(19) United States
(12) Patent Application Publication
(10) Pub. No.: US 2018/0145919 A1
(43) Pub. Date: May 24, 2018

(54) WI-FI LINK AGGREGATION

(71) Applicant: QUALCOMM Incorporated, San Diego, CA (US)

(72) Inventors: Mahesh Kumar Kalikot Veetil, San Diego, CA (US); Alireza Raissinia, Monte Sereno, CA (US); Vijay Kumar Pamidipati, Bangalore (IN); Aaditya Rai, Bangalore (IN); Abhishek Rastogi, Bangalore (IN); Rajagopal Jeenagala, San Diego, CA (US); Manikandan Mohan, San Diego, CA (US)

(21) Appl. No.: 15/679,636

(22) Filed: Aug. 17, 2017

(30) Foreign Application Priority Data
Nov. 23, 2016 (IN) 201641039972

(51) Int. Cl. H04L 12/891; H04W 28/06; H04L 12/709

(52) U.S. Cl. CPC H04L 47/41; H04W 28/22; H04L 45/245; H04W 28/06

(57) ABSTRACT

Techniques for wireless communication are described. One method includes receiving, at a first protocol layer of a wireless communications device, data flows from a second protocol layer for transmission on a first sub-band of a shared radio frequency spectrum band or a second sub-band of the shared radio frequency spectrum band, the second protocol layer being a higher protocol layer than the first protocol layer; scheduling the data flows from the first protocol layer or the second protocol layer to the first sub-band of the shared radio frequency spectrum band or the second sub-band of the shared radio frequency spectrum band based on a parameter associated with the data flows and at least one metric associated with at least one of the first sub-band or the second sub-band; and aggregating the data flows for transmission over the first sub-band and the second sub-band based on the scheduling.

### CROSS REFERENCES

The present Application for Patent claims priority to U.S. Provisional Patent Application No. 201641039972 by Kalikot Veetil, et al., entitled “WI-FI LINK AGGREGATION,” filed Nov. 23, 2016, assigned to the assignee hereof.

### BACKGROUND

The following relates generally to wireless communication, and more specifically to Wi-Fi link aggregation to improve throughput performance.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices.

Some examples of wireless communication system may include single or dual-band APs. A dual-band AP may allow communication between a STA and a wireless network using multiple different wireless protocols (e.g., WLAN, Long-Term Evolution (LTE), etc.). A single-band AP may transmit data using a single radio communication link in one frequency range (e.g., sub-band). Alternatively, simultaneous dual-band APs may transmit data using multiple radio communication links in different frequency ranges (e.g., different sub-bands). In some examples, the AP may be coupled to a network, such as the Internet, and may enable a STA to communicate via the network (or communicate with other devices coupled to the AP). A STA may communicate with a network device bi-directionally. The STA may communicate with the AP or other devices via one or more channels or links, such as over a 2.4 GHz and/or a 5 GHz link. For example, in a WLAN, when a STA requests resources for high quality video streaming from an AP, it may communicate with the AP via a first channel, such as a 5 GHz channel. Alternatively, when the STA requests resources for web browsing from the AP, it may be beneficial for the STA to communicate over a different channel, such as a 2.4 GHz channel. In some techniques these channels can be aggregated to provide better throughput, reliability, etc.

### SUMMARY

The described techniques relate to improved methods, systems, devices, or apparatuses that support Wi-Fi link aggregation to improve throughput performance. Some examples of wireless communication systems may include single or dual-band APs or STAs. A single band AP or STA may transmit data packets using one frequency channel. Alternatively, dual-band APs or STAs may transmit data packets using multiple frequency channels. An AP or STA may support data flow aggregation using multiple bands simultaneously.

A method of wireless communication is described. The method may include receiving, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer; scheduling the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and aggregating the data flows for transmission over the first sub-band of the shared radio frequency spectrum band and the second sub-band of the shared radio frequency spectrum band based at least in part on the scheduling.

An apparatus for wireless communication is described. The apparatus may include means for receiving, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer; means for scheduling the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and means for aggregating the data flows for transmission over the first sub-band of the shared radio frequency spectrum band and the second sub-band of the shared radio frequency spectrum band based at least in part on the scheduling.

Another apparatus for wireless communication is described. The apparatus may include a processor; memory in electronic communication with the processor; and instructions stored in the memory and operable, when executed by the processor, to cause the apparatus to receive, at a first protocol layer of the apparatus, data flows from a second protocol layer for transmission on a first sub-band of a shared radio frequency spectrum band or a second sub-band of the shared radio frequency spectrum band, the second protocol layer being a higher protocol layer than the first protocol layer; schedule the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and aggregate the data flows for transmission over the first sub-band of the shared radio frequency spectrum band and the second sub-band of the shared radio frequency spectrum band based at least in part on the scheduling.

A non-transitory computer readable medium for wireless communication is described. The non-transitory computer-readable medium may include instructions operable to cause a processor to receive, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer; schedule the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and aggregate the data flows for transmission over the first sub-band of the shared radio frequency spectrum band and the second sub-band of the shared radio frequency spectrum band based at least in part on the scheduling.

Some examples of the method, apparatus, and non-transitory computer-readable medium described above for scheduling the data flows may further include processes, features, means, or instructions for migrating data flows scheduled to the first sub-band of the shared radio frequency spectrum band to the second sub-band of the shared radio frequency spectrum band based at least in part on the parameter; and transmitting the migrated data flows over the second sub-band of the shared radio frequency spectrum band.

Some examples of the method, apparatus, and non-transitory computer-readable medium described above for scheduling the data flows may further include processes, features, means, or instructions for determining that the at least one metric of the first sub-band of the shared radio frequency spectrum band satisfies a transmission bandwidth threshold, the at least one metric comprising a transmission bandwidth; and scheduling the data flows to the second sub-band of the shared radio frequency spectrum band based at least in part on the determination.

Some examples of the method, apparatus, and non-transitory computer-readable medium described above may further include processes, features, means, or instructions for monitoring the at least one metric associated with the at least one of the first sub-band of the shared radio frequency spectrum band or the second sub-band of the shared radio frequency spectrum band; determining that a value for the at least one monitored metric for the first sub-band of the shared radio frequency spectrum band exceeds a predetermined threshold; and scheduling subsequent data flows to the second sub-band of the shared radio frequency spectrum band based at least in part on the determining.

Some examples of the method, apparatus, and non-transitory computer-readable medium described above may further include processes, features, means, or instructions for receiving, at the first protocol layer, a request for an amount of bandwidth from the second protocol layer; analyzing the at least one metric associated with the at least one of the first sub-band of the shared radio frequency spectrum band or the second sub-band of the shared radio frequency spectrum band based at least in part on the received request; and allocating a portion of bandwidth for the first sub-band of the shared radio frequency spectrum band to the second sub-band of the shared radio frequency spectrum band based at least in part on the analyzing.

Some examples of the method, apparatus, and non-transitory computer-readable medium described above may further include processes, features, means, or instructions for configuring, for the data flows, a receiver address, or a transmitter address, or a destination address, or a source address, or a combination thereof. Some examples of the method, apparatus, and non-transitory computer-readable medium described above for aggregating the data flows may further include processes, features, means, or instructions for identifying an aggregation mode based at least in part on information associated with the received data flows; and aggregating the data flows over the first sub-band of the shared radio frequency spectrum band and the second sub-band of the shared radio frequency spectrum band is further based at least in part on the identified aggregation mode.

Some examples of the method, apparatus, and non-transitory computer-readable medium described above may further include processes, features, means, or instructions for identifying a virtual local area network (VLAN) tag associated with the data flows; and forwarding the received data flows from the first protocol layer to the first sub-band of the shared radio frequency spectrum band or the second sub-band of the shared radio frequency spectrum band based at least in part on the identified VLAN tag. Some examples of the method, apparatus, and non-transitory computer-readable medium described above may further include processes, features, means, or instructions for removing the VLAN tag from the received data flows prior to forwarding the received data flows.

Some examples of the method, apparatus, and non-transitory computer-readable medium described above may further include processes, features, means, or instructions for analyzing a hash mapper table based at least in part on the received data flows; and forwarding the received data flows from the first protocol layer to the first sub-band of the shared radio frequency spectrum band or the second sub-band of the shared radio frequency spectrum band based at least in part on the analyzed hash mapper table. In some examples of the method, apparatus, and non-transitory computer-readable medium described above, the decoding is performed at a host driver layer.

Some examples of the method, apparatus, and non-transitory computer-readable medium described above may further include processes, features, means, or instructions for configuring an address field for the data flows to include an indication of tunneling over the second sub-band. Some examples of the method, apparatus, and non-transitory computer-readable medium described above may further include processes, features, means, or instructions for receiving a vendor specific information element (IE) in a data packet of at least one of the data flows; and utilizing the at least one vendor specific IE to exchange bonding capabilities.

In some examples of the method, apparatus, and non-transitory computer-readable medium described above, the vendor specific IE comprises a buffer size, or a media access control (MAC) address, or a channel number, or a bandwidth, or a number of chains, or a combination thereof, of at least one of the first sub-band of the shared radio frequency spectrum band or the second sub-band of the shared radio frequency spectrum band.

Some examples of the method, apparatus, and non-transitory computer-readable medium described above may further include processes, features, means, or instructions for encapsulating a data packet of at least one of the data flows to include at least two MAC address types. In some examples of the method, apparatus, and non-transitory computer-readable medium described above, the at least two MAC address types comprise a source address and a destination address. In some examples of the method, apparatus, and non-transitory computer-readable medium described above, the encapsulated data packet further comprises at least two Ethernet address types and a VLAN indication. Some examples of the method, apparatus, and non-transitory computer-readable medium described above may further include processes, features, means, or instructions for encapsulating a data packet of at least one of the data flows to include an outer MAC header and an inner MAC header; and preserving the inner MAC header based at least in part on the outer MAC header.

In some examples of the method, apparatus, and non-transitory computer-readable medium described above, the at least one metric comprises a signal strength, or a transmission bandwidth, or a link capacity, or a combination thereof. In some examples of the method, apparatus, and non-transitory computer-readable medium described above, the parameter comprises at least one a power saved mode, or link statistics, or a link failure indication, or data flow statistics, or rate adaptation, or input from a framework, or a combination thereof.

In some examples of the method, apparatus, and non-transitory computer-readable medium described above, the data flows are scheduled at the second protocol layer; and the data flows are aggregated at the first protocol layer. In some examples of the method, apparatus, and non-transitory computer-readable medium described above, the second protocol layer comprises an application layer; and the first protocol layer comprises a host driver layer. In some examples of the method, apparatus, and non-transitory computer-readable medium described above, the first sub-band of the shared radio frequency spectrum band comprises a 2.4 GHz band link; the second sub-band of the shared radio frequency spectrum band comprises a 5 GHz band link.

### BRIEF DESCRIPTION OF THE DRAWINGS

FIG. 1 illustrates an example of a system for wireless communication that supports Wi-Fi link aggregation to improve throughput performance in accordance with aspects of the present disclosure.

FIG. 2 illustrates an example of a block diagram of an example of wireless communications between an AP and a STA that supports Wi-Fi link aggregation to improve throughput performance in accordance with aspects of the present disclosure.

FIG. 3 illustrates an example of a system architecture for wireless communication that supports Wi-Fi link aggregation to improve throughput performance in accordance with aspects of the present disclosure.

FIG. 4 illustrates an example of a system architecture for wireless communication that supports Wi-Fi link aggregation to improve throughput performance in accordance with aspects of the present disclosure.

FIG. 5 illustrates an example of a system architecture for wireless communication that supports Wi-Fi link aggregation to improve throughput performance in accordance with aspects of the present disclosure.

FIG. 6 illustrates an example of a system architecture for wireless communication that supports Wi-Fi link aggregation to improve throughput performance in accordance with aspects of the present disclosure.

FIG. 7 illustrates an example method that supports Wi-Fi link aggregation to improve throughput performance in accordance with aspects of the present disclosure.

FIGS. 8 through 10 show block diagrams of a device that supports Wi-Fi link aggregation to improve throughput performance in accordance with aspects of the present disclosure.

FIG. 11 illustrates a block diagram of a system including a STA supports Wi-Fi link aggregation to improve throughput performance in accordance with aspects of the present disclosure.

FIG. 12 illustrates a block diagram of a system including an AP supports Wi-Fi link aggregation to improve throughput performance in accordance with aspects of the present disclosure.

FIGS. 13 and 14 illustrate methods for Wi-Fi link aggregation to improve throughput performance in accordance with aspects of the present disclosure.

### DETAILED DESCRIPTION

Some examples of wireless communication systems support single data flow or multiple data flow. Single data flow systems may include an AP or STA transmitting or receiving data packets using a single frequency channel of a shared frequency spectrum band. In some cases, the AP or STA may transmit or receive data packets on a sub-band of a shared frequency spectrum band. Alternatively, for multiple data flow systems, an AP or STA may transmit or receive data packets using multiple frequency channels of a shared frequency spectrum band. In some cases, the AP or STA may transmit or receive data packets on multiple sub-bands of the shared frequency spectrum band. In some examples, dual-band operation at an AP or STA may include using multiple frequency channels for improving throughput of data packets. For example, an AP or STA may be associated with a first frequency channel and a second frequency channel. In some cases, the first frequency channel may be different from the second frequency channel. In other cases, the first frequency channel may be same as the second frequency channel.

An AP or STA, may support dual-band operation by using multiple frequency channels for transmitting or receiving data packets concurrently. An AP may transmit data packets to a STA using a first frequency channel (e.g., 5 GHz) and receive data from the STA using a second frequency channel (e.g., 2.4 GHz). For example, when a STA requests resources for high quality video streaming from an AP, it may communicate with the AP via a 5 GHz channel. Alternatively, when the STA requests resources for web browsing from the AP, it may be beneficial for the STA to communicate over a different channel, such as a 2.4 GHz channel. In some examples, the AP may analyze received data flows (i.e., data packets) and metrics associated with frequency channels to aggregate the received data flows for transmission over a frequency channel. As a result, the dual-band operation may improve throughput at an AP or STA by aggregating data flows to an available frequency channel of a shared frequency spectrum band.

Aspects of the disclosure are initially described in the context of a wireless communications system. Exemplary STAs, APs, system architecture, and process flows that support Wi-Fi link aggregation to improve throughput performance are then described. Aspects of the disclosure are further illustrated by and described with reference to apparatus diagrams, system diagrams, and flowcharts that relate to Wi-Fi link aggregation to improve throughput performance.

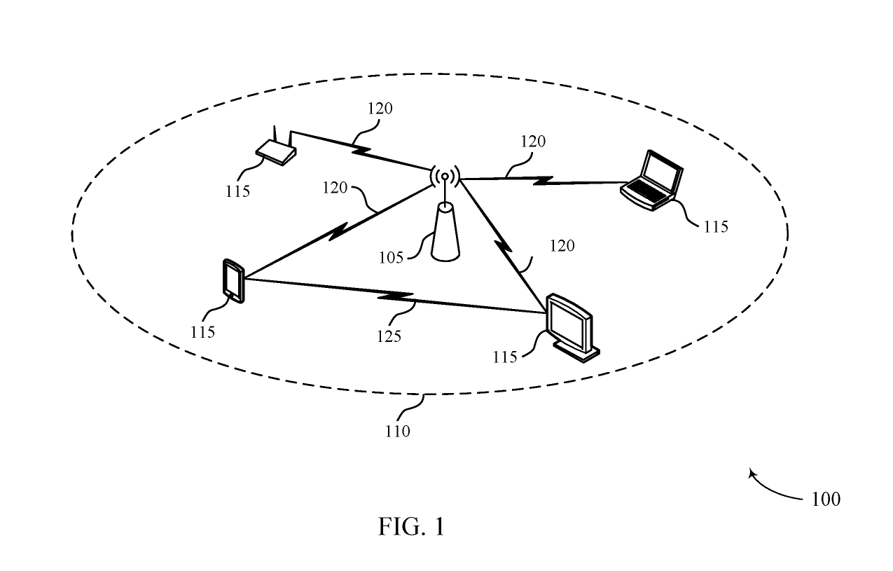

FIG. 1 illustrates an example of a system 100 for wireless communication that supports Wi-Fi link aggregation to improve throughput performance in accordance with aspects of the present disclosure. Specifically, FIG. 1 illustrates a WLAN (also known as a Wi-Fi network) configured in accordance with various aspects of the present disclosure. The system 100 may include an AP 105 and multiple associated STAs 115, which may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. The AP 105 and the STAs 115 may represent a basic service set (BSS) or an extended service set (ESS). The various STAs 115 in the WLAN may be able to communicate with one another through the AP 105. Also shown is a coverage area 110 of the AP 105, which may represent a basic service area (BSA) of the WLAN. An extended network station (not shown) associated with the WLAN may be connected to a wired or wireless distribution system that may allow multiple APs 105 to be connected in an ESS.

In some cases, it may be beneficial for AP 105 or STAs 115 to communicate over multiple carriers or links, which may be represented by communication links 120 or 125. A STA 115 may have high throughput requirements, for example, to meet the requirements of a particular application (e.g., streaming video, web-browsing, etc.) or to improve performance of an application. In these and other cases, the STA 115 may establish a communication link with AP 105, which may include two or more different communication links. In some cases of system 100, AP 105 or STAs 115 may support data flow aggregation for dual-band operation. A data flow may be associated with a stream of data packets that correspond to a transmission chain. In some cases, a data flow may include a number of data packets. For example, a data flow may include five data packets (i.e., 5-tuple). AP 105 or STAs 115 may analyze the stream of data packets to determine one or more radio communication links (e.g., one or more sub-bands of a shared radio frequency spectrum band) for transmitting the data packets. Analyzing the data packets, in some examples, may include identifying an available amount of bandwidth for transmitting the data packets. Subsequent to identifying the available amount of bandwidth and the sub-band, AP 105 or STAs 115 may direct and aggregate the data packets to one or more radio communication links (e.g., one or more sub-bands of a shared radio frequency spectrum band) for transmission.

Additionally or alternatively, AP 105 may identify a destination STA associated with the data flow based on information included in one or more data packets of the data flow. For example, AP 105 may receive at least one vendor specific IE in a data packet of a data flow. In some examples, the at least one vendor specific IE may indicate information associated with a one or more sub-bands of a shared radio frequency spectrum band. For example, a vendor specific IE may include a buffer size, or a MAC address, or a channel number, or a bandwidth, or a number of chains, or a combination thereof of at least one of a first sub-band of a shared radio frequency spectrum band or a second sub-band of a shared radio frequency spectrum band.

Additionally, in some cases, prior to directing data packets to one or more sub-bands of a shared radio frequency spectrum band, AP 105 or STAs 115 may analyze one or more metrics associated with sub-band of a shared radio frequency spectrum band (e.g., communication link 120). For example, AP 105 may determine whether a sub-band has enough transmission bandwidth to transmit the data packets. Alternatively, AP 105 may utilize an additional sub-band to transmit the data packets when there is not enough bandwidth to transmit the data packets on a single sub-band (e.g., radio communication link). For example, if AP 105 or STA 115 determines that the received data packets occupy more bandwidth than is available by a first radio communication link (e.g., 2.4 GHz frequency channel), the AP may direct the data packets to a second radio communication link (e.g., 5 GHz frequency channel) for transmission.

In some examples, AP 105 or STA 115 may forward pending data packets of a data flow to an available radio communication link that is ready to transmit. In some cases, AP 105 or STA 115 may forward pending data packets of a data flow to an available sub-band of a shared radio frequency spectrum band that is available for transmission. AP 105 or STA 115 may monitor one or more hardware components for queueing and directing data packets of a data flow based on a watermark. AP 105 or STA 115 may also migrate data packets of one or more data flows to one or other radio communication links (e.g., bands or sub-bands of a shared radio frequency spectrum) based on link performance and link failure. In some cases, a receiver of AP 105 or STA 115 may forward data packets of a data flow to a reorder buffer, e.g., because of transmission failure. The reorder buffer may transmit data packets of a data flow to a protocol layer. In some cases, the reorder buffer may be erased after some predetermined amount of time.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links may include Wi-Fi Direct connections, Wi-Fi Tunneled Direct Link Setup (TDLS) links, and other group connections. STAs 115 and APs 105 may communicate according to a WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within system 100. Devices in wireless communications system 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

In some cases, a STA 115 or an AP 105 may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an request-to-send (RTS) packet transmitted by a sending STA 115 (or AP 105) and a clear-to-send (CTS) packet transmitted by the receiving STA 115 (or AP 105). This may alert other devices within range of the sender and receiver not to transmit for the duration of the primary transmission. Thus, RTS/CTS may help mitigate a hidden node problem.

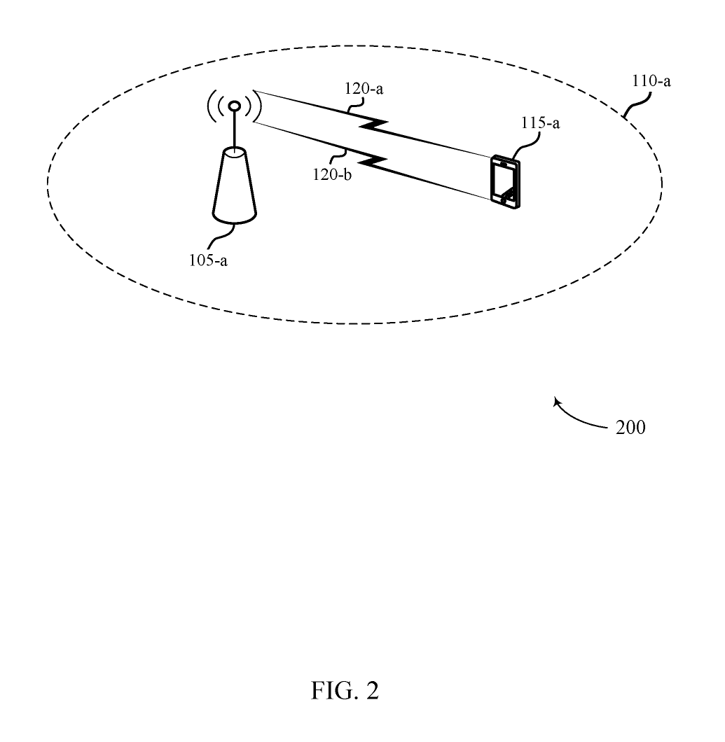

FIG. 2 illustrates an example of a block diagram 200 of an example of wireless communications between an AP 105-a and a STA 115-a that supports Wi-Fi link aggregation to improve throughput performance in accordance with aspects of the present disclosure. STA 115-a and AP 105-a may be examples of STAs 115 and AP 105 described in reference to FIG. 1. The AP 105-a may communicate with STA 115-a over a first radio communication link 120-a. The first radio communication link 120-a may be associated with a first sub-band of a shared radio frequency spectrum band. In some examples, the first radio communication link 120-a at times may, however, not yield enough throughput for certain communications between the STA 115-a and AP 105-a, such as streaming video or transferring large files, certain applications operating on the STA 115-a or AP 105-a. In these cases, it may be beneficial for either STA 115-a or AP 105-a to aggregate and/or migrate data flows associated with certain communications between STA 115-a and AP 105-a to an additional radio communication link.

The AP 105-a (or STA 115-a) may receive, at a first protocol layer, data flows from a second protocol layer or STA 115-a for transmission on a first sub-band (e.g., 2.4 GHz band link) of a shared radio frequency spectrum band of the first radio communication link 120-a or a second sub-band (e.g., 5.0 GHz band link) of the shared radio frequency spectrum band of a second radio communication link 120-b. The first protocol layer may include a host driver layer, and the second protocol layer may include an application layer. AP 105-a may schedule the data flows from the first protocol layer or the second protocol layer to the first sub-band of the shared radio frequency spectrum band of the first radio communication link 120-a or the second sub-band of the shared radio frequency spectrum band of the second radio communication link 120-b. In some cases, the AP 105-a may schedule the data flows based on a parameter associated with the data flows and a metric associated with the first sub-band of the first radio communication link 120-a or the second sub-band of the second radio communication link 120-b. AP 105-a may aggregate the data flows for transmission over the first sub-band of the shared radio frequency spectrum band of the first radio communication link 120-a and the second sub-band of the shared radio frequency spectrum band of the second radio communication link 120-b based on the scheduling.

In some examples, AP 105-a may schedule the data flows from the first protocol layer or the second protocol layer to the first sub-band of the shared radio frequency spectrum band of the first radio communication link 120-a or the second sub-band of the shared radio frequency spectrum band of the second radio communication link 120-b by determining that the at least one metric of the first sub-band of the shared radio frequency spectrum band satisfies a transmission bandwidth threshold. As a result, AP 105-a may schedule the data flows to the second sub-band of the shared radio frequency spectrum band based on the determination. In some cases, the at least one metric may include a transmission bandwidth. Additionally or alternatively, the at least one metric may include a signal strength or a link capacity, or both.

In some cases, the AP 105-a (or STA 115-a) may migrate data flows scheduled to the first sub-band of the shared radio frequency spectrum band to the second sub-band of the shared radio frequency spectrum band based on the parameter. The parameter may include at least one a power saved mode, or link statistics, or a link failure indication, or data flow statistics, or rate adaptation, or input from a framework, or a combination thereof. For example, the AP 105-a (or STA 115-a) may migrate data flows scheduled to the first sub-band of the shared radio frequency spectrum band to the second sub-band of the shared radio frequency spectrum band based on a power save mode, or a link statistics, or a link failure indication, or a data flow statistics, or a rate adaptation, or an input from a framework, or a combination thereof. The AP 105-a (or STA 115-a) may also transmit the migrated data flows over the second sub-band of the shared radio frequency spectrum band.

In some cases, the AP 105-a (or STA 115-a) may monitor a metric associated with the first sub-band of the shared radio frequency spectrum band or the second sub-band of the shared radio frequency spectrum band, or both. For example, AP 105-a (or STA 115-a) may monitor a transmission bandwidth associated with the first sub-band or the second sub-band of the shared radio frequency spectrum band, or both. Additionally, AP 105-a (or STA 115-a) may monitor a power save mode, or a link statistics, or a link failure indication, or a data flow statistics, or a rate adaptation, or an input from a framework, or a combination thereof associated with the first sub-band or the second sub-band of the shared radio frequency spectrum band, or both. The AP 105-a (or STA 115-a) may determine that a value for the monitored metric for the first sub-band of the shared radio frequency spectrum band exceeds a predetermined threshold. For example, AP 105-a (or STA 115-a) may determine that a data flow statistics or a rate adaptation of the first sub-band of the shared radio frequency spectrum band exceeds a predetermined data flow threshold or a rate adaptation threshold. In some cases, the AP 105-a (or STA 115-a) may schedule subsequent data flows to the second sub-band of the shared radio frequency spectrum band based on the determining. For example, AP 105-a (or STA 115-a) may determine that a transmission bandwidth of the first sub-band of the shared radio frequency spectrum band exceeds a predetermined transmission bandwidth threshold. As such, AP 105-a (or STA 115-a) may schedule subsequent data flows to the second sub-band of the shared radio frequency spectrum band based on determining that the predetermined transmission bandwidth threshold is satisfied for the first sub-band of the shared radio frequency spectrum band. In this case, AP 105-a (or STA 115-a) may also determine that a transmission bandwidth of the second sub-band of the shared radio frequency spectrum band is below a predetermined transmission bandwidth threshold. In some examples, the data flows may be scheduled at the second protocol layer, and the data flow may be aggregated at the first protocol layer.

The AP 105-a (or STA 115-a) may, at the first protocol layer of AP 105-a (or STA 115-a), a request for an amount of bandwidth from a second protocol layer. The AP 105-a (or STA 115-a) may a metric associated with the first sub-band of the shared radio frequency spectrum band or the second sub-band of the shared radio frequency spectrum band, or both based on the received request. Similarly, the metric may include, but is not limited to, a signal strength, or a transmission bandwidth, or a link capacity, or a combination thereof. The AP 105-a (or STA 115-a) may allocate a portion of bandwidth from the first sub-band of the shared radio frequency spectrum band to the second sub-band of the shared radio frequency spectrum band based on the analyzing. For example, the second protocol layer of AP 105-a (or STA 115-a) may be processing a broadband application service, and as such may need additional bandwidth to maintain a quality of service (QoS) of the broadband application service. Additionally, AP 105-a (or STA 115-a) may determine that the first protocol layer is processing less extensive services. In other words, the first protocol layer may only be using a portion of an allocated bandwidth. As a result, AP 105-a (or STA 115-a) may allocate a portion of unused or available bandwidth from the first sub-band of the shared radio frequency spectrum band to the second sub-band of the shared radio frequency spectrum band.

The AP 105-a (or STA 115-a) may configure, for the data flows, a receiver address, or a transmitter address, or a destination address, or a source address, or a combination thereof. In some examples, AP 105-a (or STA 115-a) may schedule the data flows from the first protocol layer or the second protocol layer to the first sub-band of the shared radio frequency spectrum band or the second sub-band of the shared radio frequency spectrum band based on the receiver address, or the transmitter address, or the destination address, or the source address, or a combination thereof. The receiver address, or the transmitter address, or the destination address, or the source address, or a combination thereof may be associated with a MAC address of AP 105-a or STA 115-a. AP 105-a (or STA 115-a) may also decode an address associated with the data flows, wherein the address is a source address, or a destination address, or a combination thereof. Upon decoding, the AP 105-a (or STA 115-a) may forward the received data flows from the first protocol layer to the first sub-band of the shared radio frequency spectrum band or the second sub-band of the shared radio frequency spectrum band based on the decoded address. The decoding may be performed at a host driver layer of AP 105-a or STA 115-a.

AP 105-a or STA 115-a may configure an address field for the data flows to include an indication of tunneling over the second sub-band. For example, data flows may include multiple data packets each with an associated header. The header may include one or more fields. In some examples, AP 105-a or STA 115-a may configure an address field for the data flows to include an indication of tunneling over the second sub-band. In some cases, the indication may be provided using a single bit or multiple bits.

The AP 105-a (or STA 115-a) may aggregate data flow by identifying an aggregation mode based on information associated with one or more received data flows. As a result, AP 105-a (or STA 115-a) may aggregate the data flows over the first sub-band of the shared radio frequency spectrum band and the second sub-band of the shared radio frequency spectrum band based on the identified aggregation mode. In some cases, AP 105-a (or STA 115-a) may identify a virtual local area network (VLAN) tag associated with the data flows, and forward the received data flows from the first protocol layer to the first sub-band of the shared radio frequency spectrum band or the second sub-band of the shared radio frequency spectrum band based on the VLAN tag. Additionally or alternatively, AP 105-a (or STA 115-a) may remove the VLAN tag from the received data flows prior to forwarding the received data flows.

In some cases, AP 105-a (or STA 115-a) may receive data flows at a first protocol layer. The AP 105-a (or STA 115-a) may analyze a hash mapper table based on the received data flows, and forward the received data flows from the first protocol layer to the first sub-band of the shared radio frequency spectrum band or the second sub-band of the shared radio frequency spectrum band based on the analyzed hash mapper table.

AP 105-a may receive a vendor specific IE in a data packet or a beacon of at least one of the data flows. The vendor specific IE may include bonding capability information. In some cases, AP 105-a and STA 115-a may utilize a vendor specific IE to exchange bonding capabilities. STA 115-a may support bonding; STA 115-a may exchange a bonding capability indication with AP 105-a using a vendor specific IE. The bonding capability indication may identify a number of radio communication links to bond and a network identifier (ID). For example, STA 115-a may indicate that it has two communication links available for bonding and a VPN tunnel ID. In some cases, the vendor specific IE may include a buffer size, or a MAC address, or a channel number, or a bandwidth, or a number of chains, or a combination thereof, of a first sub-band of a shared radio frequency spectrum band or a second sub-band of a shared radio frequency spectrum band.

AP 105-a (or STA 115-a) may encapsulate a data packet of at least one of the data flows to include at least two MAC address types. The at least two MAC address types may include a source address and a destination address. In some cases, the encapsulated data packet may also include at least two Ethernet address types and a VLAN indication. In some cases, AP 105-a (or STA 115-a) may encapsulate a data packet of at least one of the data flows to include an outer MAC header and an inner MAC header, and preserve the inner MAC header based on the outer MAC header. For example, an outer MAC header may preserve and inner packet header over a non-wireless distribution system (WDS) link. AP 105-a (or a VLAN) may identify the non-WDS link and AP 105-a may identify a data packet (e.g., legacy data packets) without identifying a destination MAC address or a source MAC address, or both. In some cases, a distinct set of VLANs may be set and controlled by AP 105-a, to provides a scalable technique to combine data packets at AP 105-a.

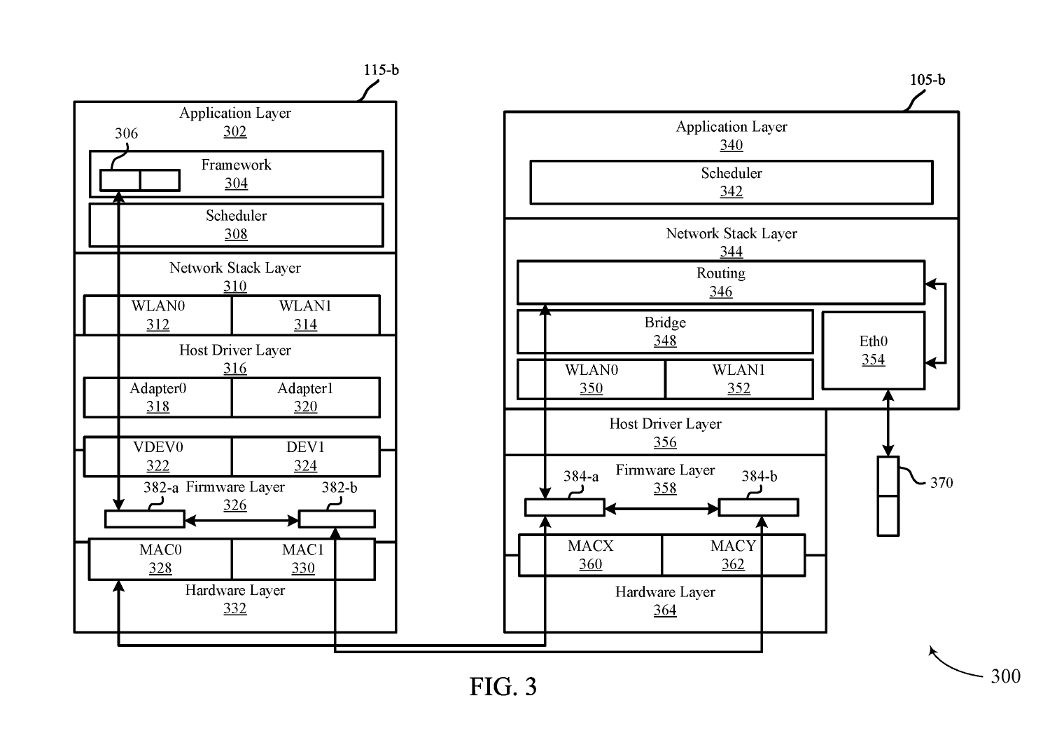

FIG. 3 illustrates an example of a system architecture 300 for wireless communication that supports Wi-Fi link aggregation to improve throughput performance in accordance with aspects of the present disclosure. System architecture 300 may include STA 115-b and AP 105-b. STA 115-b may be an example of or include the components of wireless device 805, wireless device 905, device 1105, STA 115, or STA 115-a as described above, e.g., with reference to FIGS. 1, 2, 8, 9, and 11. AP 105-b may be an example of or include the components of wireless device 805, wireless device 905, device 1205, AP 105, or AP 105-a as described above, e.g., with reference to FIGS. 1, 2, 8, 9, and 12.

STA 115-b may include an application layer 302, a network stack layer 310, a host driver layer 316, a firmware layer 326, and a hardware layer 332. The application layer 302 may support application and end-user processes. In some cases, communication partners are identified (e.g., AP 105-b and STA 115-b), QoS is identified, user authentication and privacy are considered, and any constraints on data syntax are identified. The application layer 305 may additionally provide application services for file transfers, e-mail, and other network software services. The application layer 302 may include framework 304, data flows 306, and a scheduler 308.

The framework 304 may provide higher-level services to application running on AP 105-b or STA 115-b. In some cases, framework 304 may provide controls of an application lifecycle and activity stack. Framework 304 may additionally allow applications to publish and share data with other applications. In some examples, framework 304 may provide alerts and notifications. In some case, data flows 306 may be associated with an application running on STA 115-b or AP 105-b. Data flows 306 may be associated with a stream of data packets that correspond to a transmission chain. In some cases, data flows 306 may include a number of data packets. For example, data flows 306 may include five data packets (i.e., 5-tuple). STA 115-b may analyze the stream of data packets to determine a frequency channel of a radio communication link for transmitting the data packets. Analyzing the data packets, in some examples, may include identifying an amount of bandwidth for transmitting the data packets.

The network stack layer 310 may include wireless local area network-0 (WLAN0) 312 and wireless local area network-1 (WLAN1) 314. In some cases, WLAN0 312 may operate at a first frequency channel and WLAN1 314 may operate at a second frequency channel. In some examples, the first frequency channel and the second frequency channel may be different. Alternatively, the first frequency channel and the second frequency channel may be same. The first frequency channel may be associated with a first sub-band of a shared radio frequency spectrum band (e.g., 2.4 GHz). The second frequency channel may be associated with a second sub-band of a shared radio frequency spectrum band (e.g., 5.0 GHz). The network stack layer 310 may provide transmission of data flows from STA 115-b to AP 105-b, or vice versa using WLAN0 312/WLAN1 314 and WLAN1 350/WLAN1 352.

In some examples, STA 115-b may monitor a metric associated with the first sub-band of the shared radio frequency spectrum band or the second sub-band of the shared radio frequency spectrum band, e.g., associated with WLAN0 312 and WLAN1 314. For example, STA 115-b may monitor a signal strength, or a transmission bandwidth, or a link capacity, or a combination thereof associated with WLAN0 412 and WLAN1 414. Alternatively or additionally, AP 105-b monitor a metric associated with the first sub-band of the shared radio frequency spectrum band or the second sub-band of the shared radio frequency spectrum band. For example, AP 105-b may monitor a transmission bandwidth or a link capacity, or both associated with WLAN0 350 and WLAN1 352.

Scheduler 308 in some cases may receive periodic radio communication link statistics (e.g., bandwidth, link strength, data throughput, channel congestion data, a received signal strength indicator (RSSI)). Scheduler 308 may also receive periodic data flow statistics and determine whether to migrate a data flow based on the received statistics. In some cases, scheduler 308 may be synchronized with a scheduler of an AP (e.g., scheduler 408). STA 115-b or AP 105-b may transmit marked data packets before and after migrating to reorder data packets associated with a data flow.

Scheduler 308 may schedule data flows to a first sub-band of a shared radio frequency spectrum band or a second sub-band of the shared radio frequency spectrum band. In some examples, scheduler 308 may schedule data flows based on a parameter associated with the data flows and a metric associated with each of the first sub-band of the shared radio frequency spectrum band and the second sub-band of the shared radio frequency spectrum band. A parameter may include a power saved mode, or link statistics, or a link failure indication, or data flow statistics, or rate adaptation, or input from a framework, or a combination thereof. A metric may include a signal strength, or a transmission bandwidth, or a link capacity, or a combination thereof. In some cases, scheduler 308 may migrate data flows scheduled to the first sub-band of the shared radio frequency spectrum band to the second sub-band of the shared radio frequency spectrum band based on the parameter or metric, or both. STA 115-b may transmit the migrated data flows over the second sub-band of the shared radio frequency spectrum band.

In some examples, STA 115-b may determine that a metric of the first sub-band of the shared radio frequency spectrum band satisfies a transmission bandwidth threshold. In this case, the metric may be a transmission bandwidth. For example, STA 115-b may determine that a transmission bandwidth of the first sub-band of the shared radio frequency spectrum band is below a transmission bandwidth threshold based on monitoring the metric. STA 115-b may use scheduler 308 to schedule the data flows to the second sub-band of the shared radio frequency spectrum band based on the determination.

In some cases, STA 115-b may monitor a metric associated with the first sub-band of the shared radio frequency spectrum band or the second sub-band of the shared radio frequency spectrum band, or both. For example, STA 115-b may monitor a transmission bandwidth associated with the first sub-band or the second sub-band of the shared radio frequency spectrum band, or both. Additionally, or STA 115-b may monitor a power save mode, or a link statistics, or a link failure indication, or a data flow statistics, or a rate adaptation, or an input from a framework, or a combination thereof associated with the first sub-band or the second sub-band of the shared radio frequency spectrum band, or both. The STA 115-b may determine that a value for the monitored metric for the first sub-band of the shared radio frequency spectrum band exceeds a predetermined threshold. For example, STA 115-b may determine that a data flow statistics or a rate adaptation of the first sub-band of the shared radio frequency spectrum band exceeds a predetermined data flow threshold or a rate adaptation threshold. In some cases, scheduler 308 of STA 115-b may schedule subsequent data flows to the second sub-band of the shared radio frequency spectrum band based on the determining. For example, STA 115-b may determine that a transmission bandwidth of the first sub-band of the shared radio frequency spectrum band exceeds a predetermined transmission bandwidth threshold. As such, STA 115-b may schedule subsequent data flows to the second sub-band of the shared radio frequency spectrum band based on determining that the predetermined transmission bandwidth threshold is satisfied for the first sub-band of the shared radio frequency spectrum band. In this case, STA 115-b may also determine that a transmission bandwidth of the second sub-band of the shared radio frequency spectrum band is below a predetermined transmission bandwidth threshold. In some examples, the data flows may be scheduled at the second protocol layer, and the data flow may be aggregated at the first protocol layer.

In some cases, STA 115-b may identify data traffic associated with the data flows. Data flow may include a number of data packets, e.g., five data sequential data packets. The data packets of a data flow may be associated with a same application. In some cases, scheduler 308 may use a hash mapper table for mapping a data flow to a port. In some cases, STA 115-b may use scheduler 308 to schedule data flows based on the identified data traffic.

The host driver layer 316 may provide one or more functionalities for application layer 302 to communicate with one or more components of STA 115-b. The host driver layer 316 may include an adapter0 318 and adapter1 320. Adapter0 318 and/or adapter1 320 may provide communication to one or more other components of STA 115-b. In some examples, virtual device (VDEV0) 322 and virtual device (VDEV1) 324 may be associated with a file manager. VDEV0 322 or VDEV1 324 may allow per-process controls associated with data flows 306 of application layer 302.

In some examples the firmware layer 326 may receive data flows from MAC0 328 and MAC1 330 associated with the hardware layer 332. In some examples, MAC1 330 may transmit data flow associated with a source address (e.g., STA 115-b) MAC0 328 to a higher layer or to AP 105-b. In some examples, data packets of a data flow may include an address field. In some cases, the address field may include at least one of a receiver address, a transmitter address, a destination address, a source address, or a combination thereof. In some cases, MAC1 330 may receive data flows 382-b of a data flow. The data flows 382-b may be associated with an address of MAC0 328. As a result, MAC 330 may direct the data flows 328-b to VDEV0 322 associated with MAC0 328 based on the address associated with the data flows. In some examples, data flows 382-a may be forwarded to a radio communication link based on analyzing the data flows 382-a.

In some examples, the firmware layer 326 may use the hash mapper table to configure queues and map data flows to a radio communication link (e.g., sub-band of a shared frequency spectrum band). In some examples, based on the data traffic, mapping of data flows to radio communication links may be updated dynamically. For example, STA 115-b may determine whether a frequency channel has enough bandwidth to transmit data flows 382-a of data flows 306. Alternatively, STA 115-b may utilize an additional radio communication link to transmit the data flows 382-a when there is not enough bandwidth to transmit the data flows 382-a via a single radio communication link. For example, if STA 115-d determines that the received data flows 382-a occupy more bandwidth than is available by a radio communication link (e.g., 2.4 GHz frequency channel), the STA 115-b may direct the data flows 382-a to another radio communication link (e.g., 5 GHz frequency channel) for transmission. In some examples, each radio communication link may be associated with a security association in a counter mode cipher block chaining message authentication code protocol (CCMP) header of the data packet in a data flow as to avoid replay attack.

AP 105-b may include an application layer 340, a network stack layer 344, a host driver layer 356, a firmware layer 358, and a hardware layer 364. The application layer 340 may support application and end-user processes. In some cases, communication partners are identified (e.g., AP 105-b and STA 115-b), quality of service is identified, user authentication and privacy are considered at the application layer 440. The application layer 340 may additionally provide application services for file transfers and other network software services. The application layer 340 may include a scheduler 342.

Scheduler 342 may schedule data flows to a first sub-band of a shared radio frequency spectrum band or a second sub-band of the shared radio frequency spectrum band. In some examples, scheduler 342 may schedule data flows based on a parameter associated with the data flows and a metric associated with the first sub-band of the shared radio frequency spectrum band or the second sub-band of the shared radio frequency spectrum band, or both. In some case, data flows 370 may be associated with an application running on AP 105-b. Data flows 370 may be associated with a stream of data packets that correspond to a transmission chain. In some cases, data flows 370 may include a number of data packets. For example, data flows 370 may include five data packets (i.e., 5-tuple). AP 105-b may analyze the stream of data packets to determine a frequency channel of a radio communication link for transmitting the data packets. Analyzing the data packets, in some examples, may include identifying an amount of bandwidth for transmitting the data packets. In some cases, scheduler 342 may identify data traffic associated with the data flows. Data flow may include a number of data packets, e.g., five data sequential data packets. The data packets of a data flow may be associated with a same application. In some cases, scheduler 342 may use a hash mapper table for mapping a data flow to a port.

The network stack layer 344 may include routing 346, bridge 348, and ETH0 354. The network stack layer 344 may include WLAN0 350 and WLAN1 352. In some cases, WLAN0 350 may operate at a first frequency channel and WLAN1 352 may operate at a second frequency channel. In some examples, the first frequency channel and the second frequency channel may be different. Alternatively, the first frequency channel and the second frequency channel may be the same. The first frequency channel may be associated with a first sub-band of a shared radio frequency spectrum band. The second frequency channel may be associated with a second sub-band of a shared radio frequency spectrum band. The network stack layer 344 may provide transmission of data flows from AP 105-b to STA 115-b, or vice versa using WLAN0 350 and WLAN1 352. Network stack layer 344 may route data flow from WLAN0 350 to ETH0 354 via bridge 348 using one or more components of routing 346.

The host driver layer 356 may provide one or more functionalities for application layer 340 to communicate with one or more components of AP 105-b. In some examples the firmware layer 358 may receive data flows 384-b from MACY 362 associated with the hardware layer 364. In some examples, MACY 362 may forward data flows 384-b associated with a source address (e.g., AP 105-b) to MACX 360 to a higher layer or to STA 115-b. In some examples, data packets of data flows 384-a or data flows 384-b may include an address field. In some cases, the address field may include at least one of a receiver address, a transmitter address, a destination address, a source address, or a combination thereof. In some cases, MACX 360 may receive data flows 384-a. The data flows 384-a may be associated with an address of MACY 362. As a result, MACX 360 may direct the data flows 384-a to MACY 362 based on the address associated with the data flows.

In some examples the firmware layer 358 may use the hash mapper table to configure queues and map data flows to a radio communication link (e.g., sub-band of a shared frequency spectrum band. In some examples, based on the data traffic, mapping of data flows to radio communication links may be updated dynamically. For example, AP 105-b may determine whether a frequency channel has enough bandwidth to transmit data flows 384-a. Alternatively, AP 105-b may utilize an additional radio communication link to transmit the data flows 384-a when there is not enough bandwidth to transmit the data flows 382-a via a single radio communication link. For example, if AP 105-b determines that the received data flows 384-a occupy more bandwidth than is available by a radio communication link (e.g., 2.4 GHz frequency channel), the AP 105-b may direct the data flows 384-a to another radio communication link (e.g., 5 GHz frequency channel) for transmission. In some examples, each radio communication link may be associated with a security association in a CCMP header of the data packet in a data flow as to avoid replay attack.

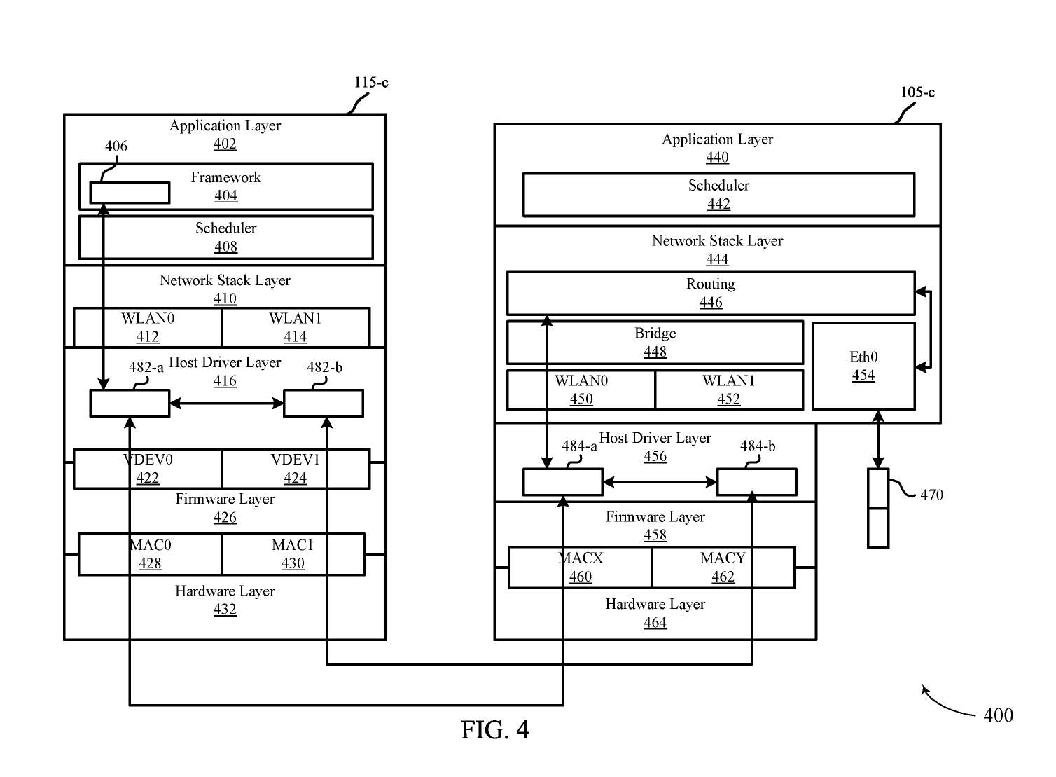

FIG. 4 illustrates an example of a system architecture 400 for wireless communication that supports Wi-Fi link aggregation to improve throughput performance in accordance with aspects of the present disclosure. System architecture 400 may include STA 115c and AP 105-c. STA 115c may be an example of or include the components of wireless device 805, wireless device 905, device 1105, STA 115, STA 115a,or STA 115-b as described above, e.g., with reference to FIGS. 1-3, 8, 9, and 11. AP 105-c may be an example of or include the components of wireless device 805, wireless device 905, device 1205, AP 105, AP 105-a, or AP 105-c as described above, e.g., with reference to FIGS. 1-3, 8, 9, and 12.

STA 115c may include an application layer 402, a network stack layer 410, a host driver layer 416, a firmware layer 426, and a hardware layer 432. The application layer 402 may support application and end-user processes. In some cases, communication partners are identified (e.g., AP 105-c and STA 115-c), quality of service is identified, user authentication and privacy are considered, etc. The application layer 405 may additionally provide application services for file transfers, e-mail, and other network software services. The application layer 402 may include framework 404, data flows 406, and a scheduler 408.

The framework 404 may provide higher-level services to application running on STA 115-c. Framework 404 may additionally allow applications to publish and share data with other applications. In some examples, framework 304 may provide alerts and notifications. In some case, data flows 406 may be associated with an application running on STA 115-c. Data flows 406 may be associated with a stream of data packets that correspond to a transmission chain. In some cases, data flows 406 may include a number of data packets. For example, data flows 406 may include five data packets (i.e., 5-tuple). STA 115c may analyze the stream of data packets to determine a frequency channel of a radio communication link for transmitting the data packets. Analyzing the data packets, in some examples, may include identifying an amount of bandwidth for transmitting the data packets.

The network stack layer 410 may include WLAN0 412 and WLAN1 414. In some cases, WLAN0 412 may operate at a first frequency channel and WLAN1 414 may operate at a second frequency channel. In some examples, the first frequency channel and the second frequency channel may be different. Alternatively, the first frequency channel and the second frequency channel may be same. The network stack layer 410 may provide transmission of data flows from STA 115c to AP 105-c, or vice versa using WLAN0 412/WLAN1 414 or WLAN0 450/WLAN1 452.

In some examples, STA 115c may monitor a metric associated with the first sub-band of the shared radio frequency spectrum band and the second sub-band of the shared radio frequency spectrum band, e.g., associated with WLAN0 412 and WLAN1 414. Scheduler 408 may schedule data flows to a first sub-band of a shared radio frequency spectrum band or a second sub-band of the shared radio frequency spectrum band. In some examples, scheduler 408 may schedule data flows based on a parameter associated with the data flows and a metric associated with each of the first sub-band of the shared radio frequency spectrum band and the second sub-band of the shared radio frequency spectrum band. The parameter may include a power saved mode, or link statistics, or a link failure indication, or data flow statistics, or rate adaptation, or input from a framework, or a combination thereof. The metric may include a signal strength, or a transmission bandwidth, or a link capacity, or a combination thereof. In some cases, STA 115c may determine that a transmission bandwidth of the first sub-band of the shared radio frequency spectrum band is below a transmission bandwidth threshold based on the monitoring. STA 115c may use scheduler 408 to schedule subsequent data flows to the second sub-band of the shared radio frequency spectrum band based on the determining.

In some cases, STA 115c may identify data traffic associated with the data flows. Data flow may include a number of data packets, e.g., five data sequential data packets. The data packets of a data flow may be associated with a same application. In some cases, scheduler 408 may use a hash mapper table for mapping a data flow to a port. In some cases, STA 115c may use scheduler 408 to schedule data flows based on the identified data traffic.

The host driver layer 416 may provide one or more functionalities for application layer 402 to communicate with one or more components of STA 115-c. In some examples STA 115c may receive data flows from MAC0 428 and/or MAC1 430 associated with the hardware layer 432 at the host driver layer 416. In some examples, MAC1 430 may transmit data flow associated with a source address (e.g., STA 115-c) MAC0 428 to a higher layer or to AP 105-c. In some examples, data packets of a data flow may include an address field. In some cases, the address field may include at least one of a receiver address, a transmitter address, a destination address, a source address, or a combination thereof. In some cases, MAC1 430 may receive data flows 482-b. The data flows 482-b may be associated with an address of MAC0 428. As a result, MAC1 430 may direct the data flows 428-b to VDEV0 422 associated with MAC0 428 based on the address associated with the data flows. In some examples, data flows 482-a may be forwarded to a radio communication link based on analyzing the data flows 482-a.

In some examples, STA 115c may identify a VLAN tag associated with data flows 482-a or data flows 482-b of a data flow. In some cases, STA 115c may schedule data flows 482-a or data flows 482-b for transmission on a first sub-band of a shared radio frequency spectrum band or a second sub-band of the shared radio frequency spectrum band based on the VLAN tag. In some cases, STA 115c may remove the VLAN tag from the data flows 482-a or data flows 482-b prior to transmission.

In some examples, STA 115c may use a hash mapper table to configure queues and map data flows to a radio communication link (e.g., sub-band of a shared frequency spectrum band). STA 115c may analyze a hash mapper table based on the VLAN tag and direct data flows 482-a or data flows 482-b to the first sub-band of the shared radio frequency spectrum band or the second sub-band of the shared radio frequency spectrum band based on the hash mapper table.

In some examples, based on the data traffic, mapping of data flows to radio communication links may be updated dynamically. For example, STA 115c may determine whether a frequency channel has enough bandwidth to transmit data flows 482-a of data flows 406. Alternatively, STA 115c may utilize an additional radio communication link to transmit the data flows 482-a when there is not enough bandwidth to transmit the data flows 482-a via a single radio communication link. For example, if STA 115c determines that the received data flows 482-a occupy more bandwidth than is available by a radio communication link (e.g., 2.4 GHz frequency channel), the STA 115c may direct the data flows 482-a to another radio communication link (e.g., 5 GHz frequency channel) for transmission.

AP 105-c may include an application layer 440, a network stack layer 444, a host driver layer 456, a firmware layer 458, and a hardware layer 464. The application layer 440 may support application and end-user processes. In some cases, communication partners are identified (e.g., AP 105-c and STA 115-c), quality of service is identified, user authentication and privacy are considered at the application layer 440. The application layer 440 may additionally provide application services for file transfers and other network software services. The application layer 440 may include a scheduler 442.

Scheduler 442 may schedule data flows to a first sub-band of a shared radio frequency spectrum band or a second sub-band of the shared radio frequency spectrum band. In some examples, scheduler 442 may schedule data flows based on a parameter associated with the data flows and a metric associated with each of the first sub-band of the shared radio frequency spectrum band and the second sub-band of the shared radio frequency spectrum band. For example, scheduler 442 may schedule data flows based on a power saved mode, or link statistics, or a link failure indication, or data flow statistics, or rate adaptation, or input from a framework, or a combination thereof associated with the data flows and a signal strength, or a transmission bandwidth, or a link capacity, or a combination thereof associated with each of the first sub-band of the shared radio frequency spectrum band and the second sub-band of the shared radio frequency spectrum band.

In some case, data flows 470 may be associated with an application running on AP 105-c. Data flows 470 may be associated with a stream of data packets that correspond to a transmission chain. In some cases, data flows 470 may include a number of data packets. For example, data flows 470 may include five data packets (i.e., 5-tuple). AP 105-c may analyze the stream of data packets to determine a frequency channel of a radio communication link for transmitting the data packets. Analyzing the data packets, in some examples, may include identifying an amount of bandwidth for transmitting the data packets. In some cases, scheduler 442 may identify data traffic associated with the data flows. Data flow may include a number of data packets, e.g., five data sequential data packets. The data packets of a data flow may be associated with a same application. In some cases, scheduler 442 may use a hash mapper table for mapping a data flow to a port.

The network stack layer 444 may include routing 446, bridge 448, and ETH0 454. The network stack layer 444 may include WLAN0 450 and WLAN1 452. In some cases, WLAN0 450 may operate at a first frequency channel and WLAN1 452 may operate at a second frequency channel. In some examples, the first frequency channel and the second frequency channel may be different. Alternatively, the first frequency channel and the second frequency channel may be same. The network stack layer 444 may provide transmission of data flows from AP 105-c to STA 115-c, or vice versa using WLAN0 450 and/or WLAN1 452. Network stack layer 444 may route data flow from WLAN0 450 to ETH0 454 via bridge 448 using one or more components of routing 446.

The host driver layer 456 may provide one or more functionalities for application layer 340 to communicate with one or more components of AP 105-c. In some examples the host driver layer 456 may receive data flows 484-b from MACY 462 associated with the hardware layer 464. In some examples, MACY 462 may forward data flows 484-b associated with a source address (e.g., AP 105-c) to MACX 460 to a higher layer or to STA 115-c. In some examples, data packets of data flows 484-a or data flows 484-b may include an address field. In some cases, the address field may include at least one of a receiver address, a transmitter address, a destination address, a source address, or a combination thereof. In some cases, MACX 460 may receive data flows 484-a. The data flows 484-a may be associated with an address of MACY 462. As a result, MACX 460 may direct the data flows 484-a to MACY 462 based on the address associated with the data flows.

In some examples, AP 105-c may identify a VLAN tag associated with data flows 484-a or data flows 484-b of a data flow. In some cases, AP 105-c may schedule data flows 484-a or data flows 484-b for transmission on a first sub-band of a shared radio frequency spectrum band or a second sub-band of the shared radio frequency spectrum band based on the VLAN tag. In some cases, AP 105-c may remove the VLAN tag from the data flows 484-a or data flows 484-b prior to transmission.

In some examples, AP 105-c may use a hash mapper table to configure queues and map data flows to a radio communication link (e.g., sub-band of a shared frequency spectrum band). AP 105-c may analyze a hash mapper table based on the VLAN tag and direct data flows 484-a or data flows 484-b to the first sub-band of the shared radio frequency spectrum band or the second sub-band of the shared radio frequency spectrum band based on the hash mapper table.

In some examples, based on the data traffic, mapping of data flows to radio communication links may be updated dynamically. For example, AP 105-c may determine whether a frequency channel has enough bandwidth to transmit data flows 484-a of data flows 470. Alternatively, AP 105-c may utilize an additional radio communication link to transmit the data flows 484-a when there is not enough bandwidth to transmit the data flows 484-a via a single radio communication link. For example, if AP 105-c determines that the received data flows 484-a occupy more bandwidth than is available by a radio communication link (e.g., 2.4 GHz frequency channel), the AP 105-c may direct the data flows 484-a to another radio communication link (e.g., 5 GHz frequency channel) for transmission.

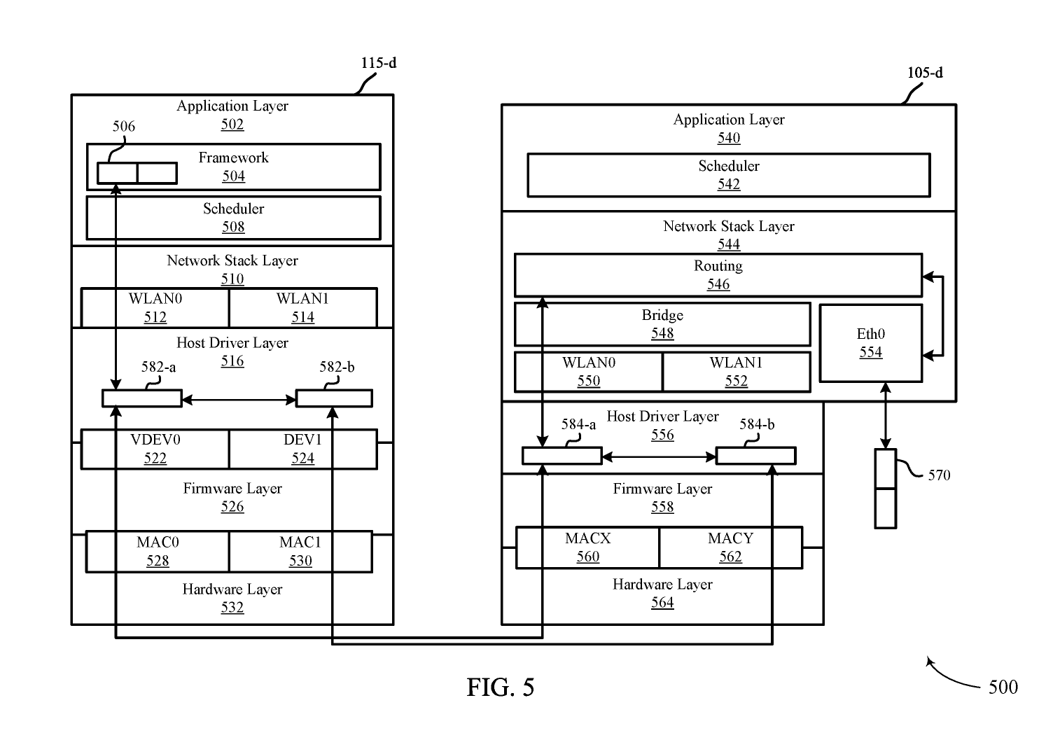

FIG. 5 illustrates an example of a system architecture 500 for wireless communication that supports Wi-Fi link aggregation to improve throughput performance in accordance with aspects of the present disclosure. System architecture 500 may include STA 115-d and AP 105-d. STA 115-d may be an example of or include the components of wireless device 805, wireless device 905, device 1105, STA 115, STA 115a, STA 115-b, or STA 115c as described above, e.g., with reference to FIGS. 1-4, 8, 9, and 11. AP 105-d may be an example of or include the components of wireless device 805, wireless device 905, device 1205, AP 105, AP 105-a, AP 105-b, or AP 105-c as described above, e.g., with reference to FIGS. 1-4, 8, 9, and 12.

STA 115-d may include an application layer 502, a network stack layer 510, a host driver layer 516, a firmware layer 526, and a hardware layer 532. The application layer 502 may support application and end-user processes. The application layer 505 may additionally provide application services for file transfers and other network software services. The application layer 502 may include framework 504, data flows 506, and a scheduler 508.

The framework 504 may provide higher-level services to application running on STA 115-d. Framework 504 may additionally allow applications to publish and share data with other applications. In some case, data flows 506 may be associated with an application running on STA 115-d. Data flows 506 may be associated with a stream of data packets that correspond to a transmission chain. In some cases, data flows 506 may include a number of data packets. STA 115-d may analyze the stream of data packets to determine a frequency channel of a radio communication link for transmitting the data packets. Analyzing the data packets, in some examples, may include identifying an amount of bandwidth for transmitting the data packets.

Scheduler 508 may schedule data flows to a first sub-band of a shared radio frequency spectrum band or a second sub-band of the shared radio frequency spectrum band. In some examples, scheduler 508 may schedule data flows based on a parameter associated with the data flows and a metric associated with each of the first sub-band of the shared radio frequency spectrum band and the second sub-band of the shared radio frequency spectrum band. The parameter may include a power saved mode, or link statistics, or a link failure indication, or data flow statistics, or rate adaptation, or input from a framework, or a combination thereof. The metric may include a signal strength, or a transmission bandwidth, or a link capacity, or a combination thereof. In some cases, STA 115-d may determine that a transmission bandwidth of the first sub-band of the shared radio frequency spectrum band is below a transmission bandwidth threshold based on the monitoring. STA 115-d may use scheduler 508 to schedule subsequent data flows to the second sub-band of the shared radio frequency spectrum band based on the determining.

The network stack layer 510 may include WLAN0 512 and WLAN1 514. In some cases, WLAN0 512 may operate at a first frequency channel and WLAN1 514 may operate at a second frequency channel. In some examples, the first frequency channel and the second frequency channel may be different. The network stack layer 510 may provide transmission of data flows from STA 115-d to AP 105-d using WLAN0 512/WLAN1 514 and/or WLAN0 550/WLAN1 552.

The host driver layer 516 may provide one or more functionalities for application layer 502 to communicate with one or more components of STA 115-d. In some examples STA 115-d may receive data flows from MAC0 528 and/or MAC1 530 associated with the hardware layer 532 at the host driver layer 516. In some examples, MAC1 530 may transmit data flow associated with a source address (e.g., STA 115-d) MAC0 528 to a higher layer or to AP 105-d. In some examples, data packets of a data flow may include an address field. In some cases, the address field may include at least one of a receiver address, a transmitter address, a destination address, a source address, or a combination thereof. In some cases, MAC1 530 may receive data flows 582-b of a data flow. The data flows 582-b may be associated with an address of MAC0 528. As a result, MAC1 530 may direct the data flows 528-b to VDEV0 522 associated with MAC0 528 based on the address associated with the data flows. In some examples, data flows 582-a may be forward to a radio communication link based on analyzing the data flows 582-a.

In some examples, at the host driver layer 516, STA 115-d may decode, e.g., by translating a source address associated with data flows 582-a or data flows 582-b of a data flow. In some cases, at the host driver layer 516, STA 115-d may decode, e.g., by translating a destination address associated with data flows 582-a or data flows 582-b of a data flow. STA 115-d may use scheduler 508 to schedule and direct data flows 582-a or data flows 582-b for transmission to the first sub-band of the shared radio frequency spectrum band or the second sub-band of the shared radio frequency spectrum band based on decoding the source address and the destination address. In some case, host driver layer 516 may differentiate between aggregated traffic and non-aggregated traffic based on performing a peer lookup operation. In some cases, AP 105-d may perform the peer lookup operation at host driver layer 556.

AP 105-d may include an application layer 540, a network stack layer 544, a host driver layer 556, a firmware layer 558, and a hardware layer 564. The application layer 540 may support application and end-user processes. The application layer 540 may include a scheduler 542. Scheduler 542 may schedule data flows to a first sub-band of a shared radio frequency spectrum band or a second sub-band of the shared radio frequency spectrum band. In some examples, scheduler 542 may schedule data flows based on a parameter associated with the data flows and a metric associated with each of the first sub-band of the shared radio frequency spectrum band and the second sub-band of the shared radio frequency spectrum band.

The network stack layer 544 may include routing 546, bridge 548, and ETH0 554. The network stack layer 544 may include WLAN0 550 and WLAN1 552. In some cases, WLAN0 550 may operate at a first frequency channel and WLAN1 552 may operate at a second frequency channel. In some examples, the first frequency channel and the second frequency channel may be different. The network stack layer 544 may provide transmission of data flows from AP 105-d to STA 115-d using WLAN0 550 and/or WLAN1 552. Network stack layer 544 may route data flow from WLAN0 550 to ETH0 554 via bridge 548 using one or more components of routing 546.

The host driver layer 556 may provide one or more functionalities for application layer 540 to communicate with one or more components of AP 105-d. In some examples AP 105-d may receive data flows from MACX 560 and/or MACY 562 associated with the hardware layer 564 at the host driver layer 556. In some examples, MACY 562 may transmit data flow associated with a source address (e.g., AP 105-d) MACX 560 to a higher layer or to STA 115-d. In some examples, data packets of a data flow may include an address field.

In some cases, the address field may include at least one of a receiver address, a transmitter address, a destination address, a source address, or a combination thereof. In some cases, MACY 562 may receive data flows 584-b of a data flow. The data flows 584-b may be associated with an address of MACX 560. In some examples, data flows 584-a may be forward to a radio communication link based on the address associated with the data flows 584-a. In some examples, at host driver layer 556, AP 105-d may decode, e.g., translate, a source address associated with data flows 584-a or data flows 584-b of a data flow. In some cases, at host driver layer 556, AP 105-d may decode, e.g., translate, a destination address associated with data flows 584-a or data flows 584-b of a data flow. AP 105-d may use scheduler 542 to schedule and direct data flows 584-a or data flows 584-b for transmission to the first sub-band of the shared radio frequency spectrum band or the second sub-band of the shared radio frequency spectrum band based on decoding the source address and the destination address.

In some case, host driver layer 556 may differentiate between aggregated traffic and non-aggregated traffic based on performing a peer lookup operation. In some cases, AP 105-d may perform the peer lookup operation at host driver layer 556. In some cases, AP 105-d may perform MAC address translation to hide a secondary MAC address to ARP/bridge tables associated with bridge 548.

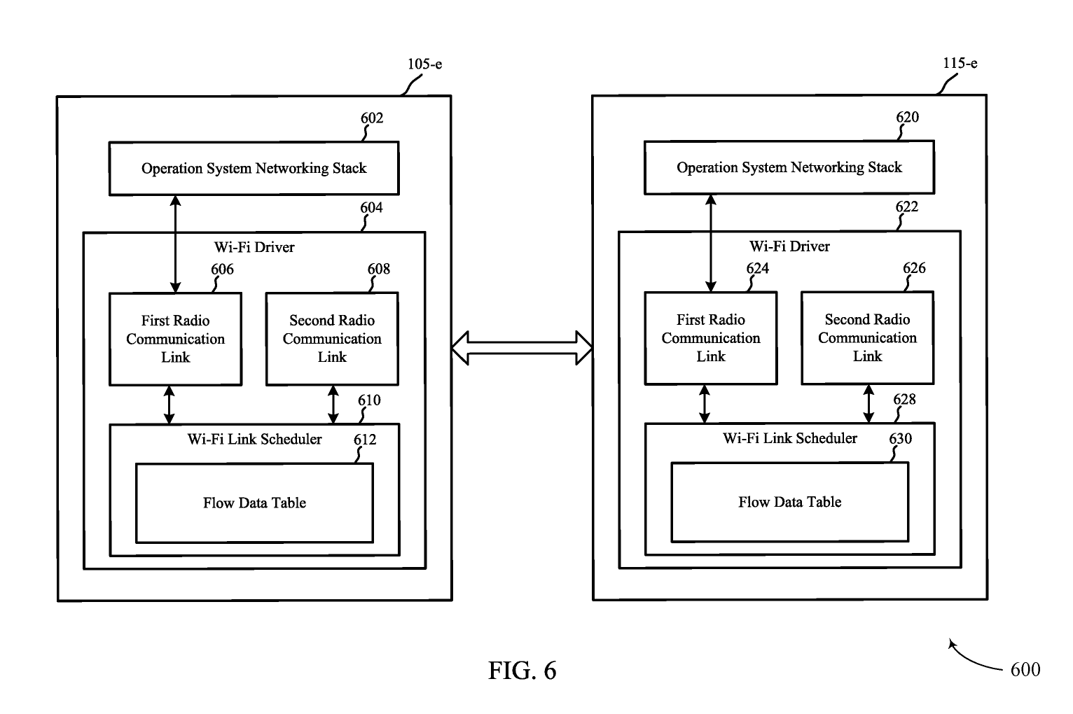

FIG. 6 illustrates an example of a system architecture 600 for wireless communication that supports Wi-Fi link aggregation to improve throughput performance in accordance with aspects of the present disclosure. STA 115-e may be an example of or include the components of wireless device 805, wireless device 905, device 1105, STA 115, STA 115a, STA 115-b, STA 115-c, or STA 115-d as described above, e.g., with reference to FIGS. 1-5, 8, 9, and 11. AP 105-e may be an example of or include the components of wireless device 805, wireless device 905, device 1205, AP 105, AP 105-a, AP 105-b, AP 105-c, or AP 105-d as described above, e.g., with reference to FIGS. 1-5, 8, 9, and 12.

AP 105-e may in some cases may act as a central coordination AP and perform load balancing and bandwidth management for one or more radio communication links. In some cases, AP 105-e may distribute data flows across multiple radio communication links based on one or more load balancing parameters or a metric (e.g., link capacity) associated with one or more radio communication links. In some examples, AP 105-e may include an operation system networking stack 602 and a Wi-Fi driver 604. Operation system networking stack 602 may include at least one of an application layer, a session layer, a transport layer, or a network layer (e.g., transmission control protocol (TCP) stack, user data protocol (UDP) stack, etc.), or a MAC layer. In some examples, operation system networking stack 602 may transmit one or more data flows to Wi-Fi driver 604 for further processing.

Wi-Fi driver 604 may include a first radio communication link 606, a second radio communication link 608 and a Wi-Fi link scheduler 610. In some cases, Wi-Fi link scheduler 610 may receive data flows from operation system networking stack 602 for transmission on a first sub-band of a shared radio frequency spectrum band associated with the first radio communication link 606. Additionally or alternatively, Wi-Fi link scheduler 610 may receive data flows from operation system networking stack 602 for transmission on a second sub-band of the shared radio frequency spectrum band associated with a second radio communication link 608.

Wi-Fi link scheduler 610 may schedule the data flows received from operation system networking stack 602 to the first sub-band of a shared radio frequency spectrum band associated with the first radio communication link 606 or the second sub-band of the shared radio frequency spectrum band associated with a second radio communication link 608. In some examples, Wi-Fi link scheduler 610 may analyze one or more entries of flow data table 612 to determine scheduling the data flows for transmission. In some examples, flow data table 612 may include a transmission history related to data flows. A transmission history may include a log of previous data flow transmissions and an associated communication link used for the previous data flow transmissions. Additionally or alternatively, the transmission history may include a database with entries associated with previous data flow transmission. For example, entries of the database may identify data packets of a data flow and corresponding parameters and metrics analyzed for a previous transmission of the data packets. For example, an entry in a database may identify a data packet, a communication link used to transmit the data packet, and a parameter (e.g., a power saved mode, or link statistics, or a link failure indication, or data flow statistics, or rate adaptation, or input from a framework, or a combination thereof) or metric (e.g., a signal strength, or a transmission bandwidth, or a link capacity, or a combination thereof) of the communication link, or both. In some cases, Wi-Fi link scheduler 610 may schedule the data flows received from operation system networking stack 602 based on a parameter associated with the data flows and a metric associated with each of the first sub-band of the shared radio frequency spectrum band and the second sub-band of the shared radio frequency spectrum band.

In some examples, Wi-Fi link scheduler 610 may identify a data traffic type of the data flows. The Wi-Fi link scheduler 610 may also identify a transmission bandwidth of the first sub-band of the shared radio frequency spectrum band associated with the first radio communication link 606 and the second sub-band of the shared radio frequency spectrum band associated with the second radio communication link 608 based on the data traffic type. In some examples, Wi-Fi link scheduler 610 may determine that the transmission bandwidth of the first sub-band of the shared radio frequency spectrum band associated with the first radio communication link 606 satisfies a transmission bandwidth threshold. Based on the determination, Wi-Fi link scheduler 610 may schedule the received data flows to the second sub-band of the shared radio frequency spectrum band associated with the second radio communication link 608. AP 105-e may transmit the data flows via the second sub-band of the shared radio frequency spectrum band using the second radio communication link 608.

In some cases, AP 105-e may monitor a metric associated with the first radio communication link 606 and the second radio communication link 608. A metric may include determining a signal strength, transmission bandwidth, link capacity, etc., between the first radio communication link 606 or second radio communication link 608 of AP 105-e and first radio communication link 624 or second radio communication link 626 of STA 115-e. AP 105-e may determine that a transmission bandwidth of the first sub-band of the shared radio frequency spectrum band or the first radio communication link 606 is below a transmission bandwidth threshold based on monitoring the first radio communication link 606. AP 105-e may as a result, schedule subsequent data flows to the second sub-band of the shared radio frequency spectrum of the second radio communication link bandwidth.

AP 105-e may also migrate data flows scheduled to the first sub-band of the shared radio frequency spectrum band to the second sub-band of the shared radio frequency spectrum band. AP 105-e may also record a change in radio communication link usage associate with data flows in the flow data table 612. In some examples, AP 105-e may receive a request from STA 115-e for an amount of bandwidth from an application running on operation system networking stack 620. The AP 105-e may analyze a metric associated with the first radio communication link 606 and the second radio communication link 608 and allocate a portion of bandwidth associated with the first sub-band of the shared radio frequency spectrum band of the first radio communication link 606 or the second sub-band of the shared radio frequency spectrum band of the second radio communication link 608. Additionally, STA 115-e may perform a similar function associated with first radio communication link 624 or second radio communication link 626.

STA 115-e may include an operation system networking stack 620 and a Wi-Fi driver 622. Operation system networking stack 620 may include at least one of an application layer, a session layer, a transport layer, or a network layer (e.g., TCP stack, UDP stack, etc.), or a MAC layer. In some examples, operation system networking stack 620 may transmit one or more data flows to Wi-Fi driver 622 for further processing.

Wi-Fi driver 604 may include a first radio communication link 606, a second radio communication link 608 and a Wi-Fi link scheduler 610. In some cases, Wi-Fi link scheduler 610 may receive data flows from operation system networking stack 602 for transmission on a first sub-band of a shared radio frequency spectrum band associated with the first radio communication link 606. Additionally or alternatively, Wi-Fi link scheduler 610 may receive data flows from operation system networking stack 602 for transmission on a second sub-band of the shared radio frequency spectrum band associated with a second radio communication link 608.

Wi-Fi link scheduler 628 may schedule the data flows received from operation system networking stack 620 or AP 105-e to the first sub-band of a shared radio frequency spectrum band associated with the first radio communication link 624 or the second sub-band of the shared radio frequency spectrum band associated with a second radio communication link 626. In some examples, Wi-Fi link scheduler 628 may analyze one or more entries of flow data table 630 to determine scheduling the data flows for transmission. In some examples, flow data table 630 may include a transmission history related to data flows. In some cases, Wi-Fi link scheduler 628 may schedule the data flows received from operation system networking stack 620 based on a parameter associated with the data flows and a metric associated with each of the first sub-band of the shared radio frequency spectrum band and the second sub-band of the shared radio frequency spectrum band. Wi-Fi link scheduler 628 may also determine that the transmission bandwidth of the first sub-band of the shared radio frequency spectrum band associated with the first radio communication link 624 satisfies a transmission bandwidth threshold.

In some examples, STA 115-e may analyze data traffic associated with one or more data flows. The Wi-Fi link scheduler 628 may also identify a transmission bandwidth of the first sub-band of the shared radio frequency spectrum band associated with the first radio communication link 624 and the second sub-band of the shared radio frequency spectrum band associated with the second radio communication link 626 based on the data traffic type.

Wi-Fi link scheduler 628 may analyze one or more metrics associated with a first sub-band of a shared radio frequency spectrum band associated with the first radio communication link 624. In some cases, Wi-Fi link scheduler 628 may determine that a value for the at least one monitored metric for the first sub-band of the shared radio frequency spectrum band exceeds a predetermined threshold. For example, Wi-Fi link scheduler 628 may determine whether a sub-band has enough transmission bandwidth to transmit the data packets. Alternatively, Wi-Fi link scheduler 628 may utilize an additional sub-band to transmit the data packets when there is not enough bandwidth to transmit the data packets on a single sub-band (e.g., radio communication link). For example, if Wi-Fi link scheduler 628 determines that the received data packets occupy more bandwidth than is available by a first radio communication link (e.g., 2.4 GHz frequency channel), the Wi-Fi link scheduler 628 may direct the data packets to a second radio communication link (e.g., 5 GHz frequency channel) for transmission. Based on the determination, Wi-Fi link scheduler 628 may schedule the received data flows to the second sub-band of the shared radio frequency spectrum band associated with the second radio communication link 626. STA 115-e may transmit the data flows via the second sub-band of the shared radio frequency spectrum band using the second radio communication link 626.

Additionally or alternatively, STA 115-e may identify a data traffic type based on analyzing TCP synchronization (SYN)/acknowledgement (ACK) frames transmitted from AP 105-e during connection establishment. STA 115-e may identify whether to use the first radio communication link 624 or the second radio communication link 626 based on the TCP SYN/ACK frames. Additionally or alternatively, STA 115-e and AP 105-e may synchronize entries of the flow data table (e.g., flow data table 612 and flow data table 630). In some cases, the synchronization of the flow data tables may be performed periodically by STA 115-e and AP 105-e.

In some cases, STA 115-e may roam and establish a connection with a different AP (not shown). STA 115-e may, in some cases, transmit information to AP 105-e indicating that the STA 115-e is about to disconnect from AP 105-e and establish a connection with a different AP. AP 105-e may, based on the indication, transmit a report associated with STA 115-e including information associated with data flows related to STA 115-e. As a result, when STA 115-e establishes a communication link with a different AP, the different AP may be aware of STA 115-e data flow. In some cases, a wireless wide area network (WWAN) capability may be checked by STA 115-e or AP 105-e prior to STA 115-e roaming. In some examples, one or more radio communication links of STA 115-e may perform roaming concurrently. Additionally, when STA 115-e roams to a new different AP, STA 115-e may update the flow data table 630. STA 115-e may also transmit information associated with the updated flow data table 630 to the new AP.

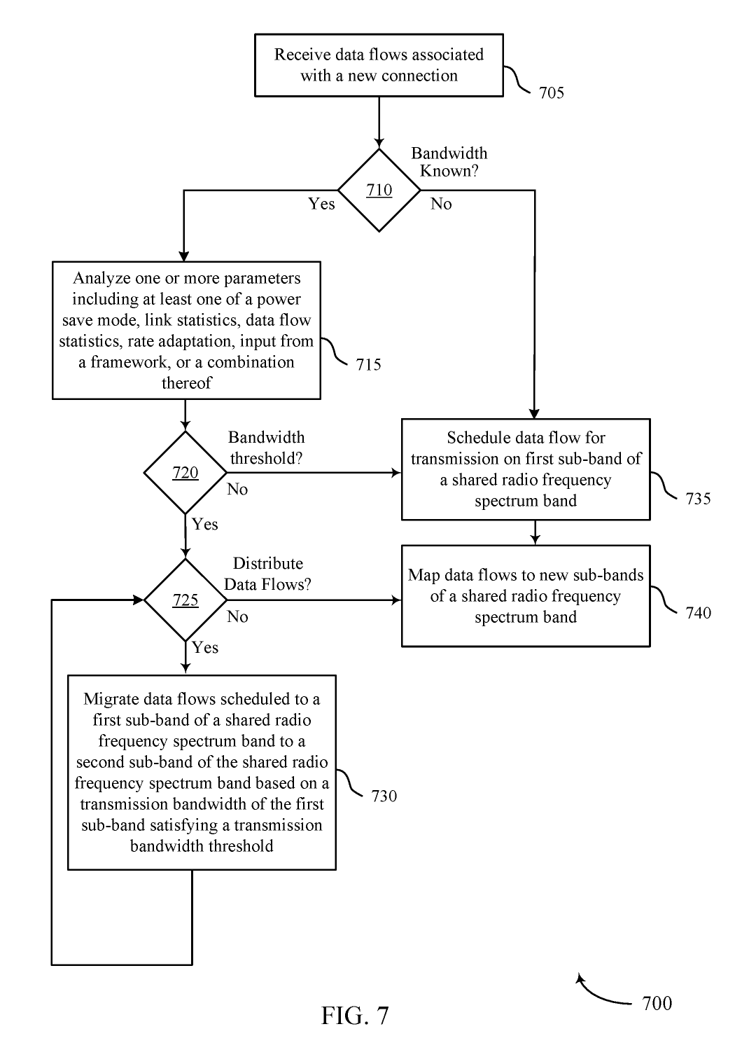

FIG. 7 illustrates an example method 700 that supports Wi-Fi link aggregation to improve throughput performance in accordance with aspects of the present disclosure. The operations of method 700 may be implemented by a STA 115 or AP 105 or its components as described herein. In some examples, a STA 115 or AP 105 may execute a set of codes to control the functional elements of the device to perform the functions described below. Additionally or alternatively, the STA 115 or AP 105 may perform aspects the functions described below using special-purpose hardware.

At block 705, STA 115 or AP 105 may receive data flows associated with a new connection. A data flow may be associated with a stream of data packets that correspond to a transmission chain. In some cases, a data flow may include a number of data packets. For example, a data flow may include five data packets (e.g., a 5-tuple). In some examples, framework (e.g., Android, iOS) of STA 115 may reserve bandwidth for the new connections.

At block 710, STA 115 or AP 105 may determine whether a bandwidth associated with the received data flows is known. In some cases, STA 115 or AP 105 may identify a transmission history related to the data flows. STA 115 or AP 105 may determine a bandwidth based on the transmission history associated with the data flows. Upon determining that a bandwidth is not known, STA 115 or AP 105 may at block 735 schedule the data flows for transmission on a first sub-band of a shared radio frequency spectrum band. In some cases, the first sub-band of a shared radio frequency spectrum band may be associated with a default MAC layer (e.g., WLAN0).

Alternatively, upon determining that a bandwidth is known, STA 115 or AP 105 may at block 715 analyze one or more parameters including at least one of a power saved mode, link statistics, data flow statistics, rate adaption, input from a framework, or a combination thereof. In some cases, STA 115 or AP 105 may use a periodic timer to check and reevaluate the parameters.

At block 720, STA 115 or AP 105 may determining whether a transmission bandwidth associated with the data flows satisfies a transmission bandwidth threshold. In some examples, the bandwidth may be associated with a consumed bandwidth, a usable rate and a radio communication link, or a combination thereof. Upon determining that the transmission bandwidth associated with the data flows satisfies the transmission bandwidth threshold, STA 115 or AP 105 may schedule the data flows for transmission on a first sub-band of a shared radio frequency spectrum band. In some cases, the first sub-band of a shared radio frequency spectrum band may be associated with a default MAC layer (e.g., WLAN0).

Alternatively, upon determining that the transmission bandwidth associated with the data flows does not satisfy the transmission bandwidth threshold, STA 115 or AP 105 may at block 725 determine whether to distribute the data flows. Upon determining not to distribute the data flows, STA 115 or AP 105 may at block 740 map the data flows to new sub-bands of a shared radio frequency spectrum band.

Alternatively, upon determining to distribute the data flows, STA 115 or AP 105 may at block 730, migrate data flows scheduled to a first sub-band of a shared radio frequency spectrum band to a second sub-band of the shared radio frequency spectrum band based on a transmission bandwidth of the first sub-band satisfying a transmission bandwidth threshold.

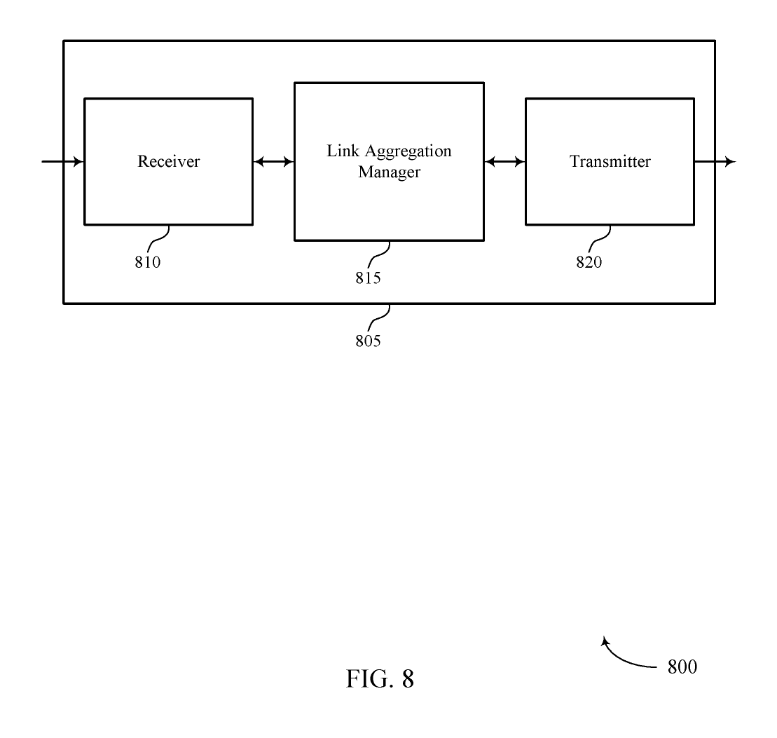

FIG. 8 shows a block diagram 800 of a wireless device 805 that supports Wi-Fi link aggregation to improve throughput performance in accordance with various aspects of the present disclosure. Wireless device 805 may be an example of aspects of a STA 115 or AP 105 as described with reference to FIG. 1. Wireless device 805 may include receiver 810, link aggregation manager 815, and transmitter 820. Wireless device 805 may also include a processor. Each of these components may be in communication with one another (e.g., via one or more buses).

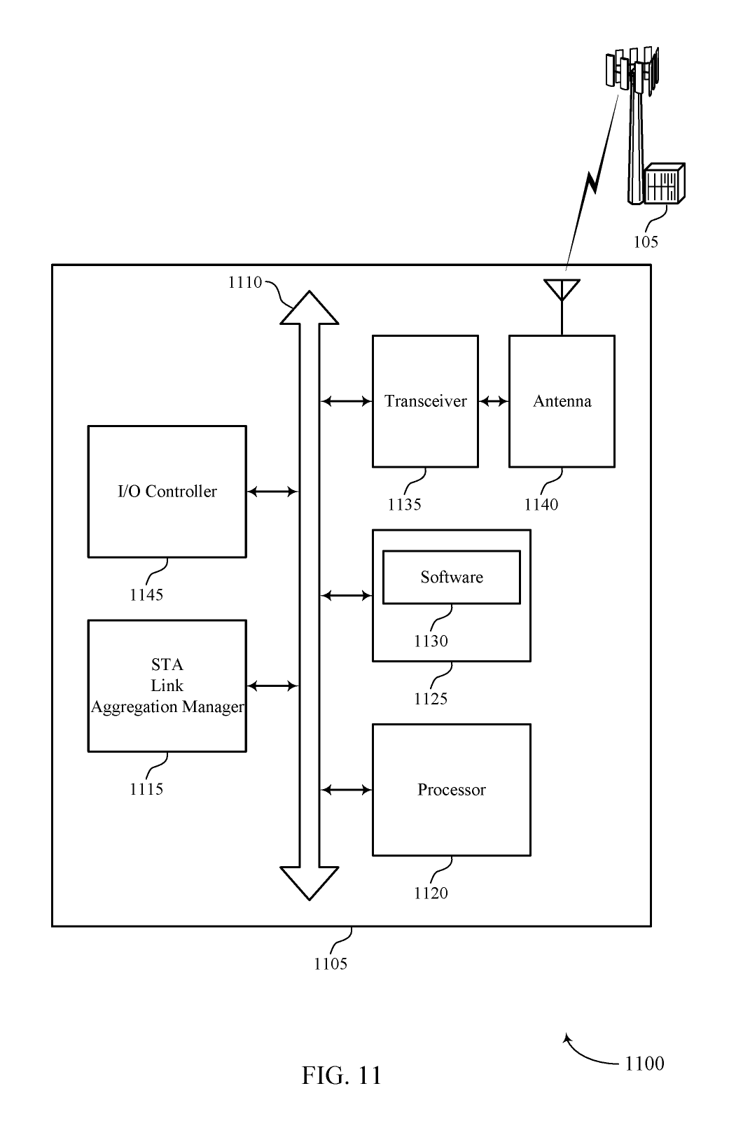

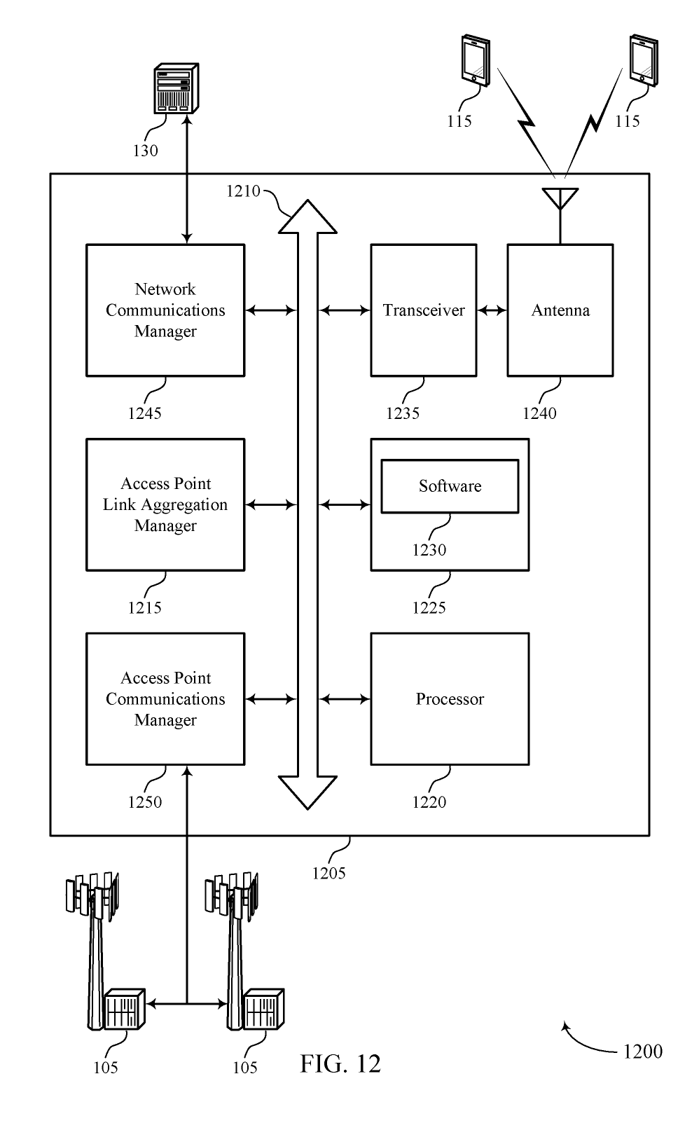

Receiver 810 may receive information such as packets, user data, or control information associated with various information channels (e.g., control channels, data channels, and information related to Wi-Fi link aggregation to improve throughput performance, etc.). Information may be passed on to other components of the device. The receiver 810 may be an example of aspects of transceiver described with reference to FIGS. 11 and 12. Receiver 810 may receive, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer.

Link aggregation manager 815 and/or at least some of its various sub-components may be implemented in hardware, software executed by a processor, firmware, or any combination thereof. If implemented in software executed by a processor, the functions of the link aggregation manager 815 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The link aggregation manager 815 and/or at least some of its various sub-components may be physically located at various positions, including being distributed such that portions of functions are implemented at different physical locations by one or more physical devices. In some examples, link aggregation manager 815 and/or at least some of its various sub-components may be a separate and distinct component in accordance with various aspects of the present disclosure. In other examples, link aggregation manager 815 and/or at least some of its various sub-components may be combined with one or more other hardware components, including but not limited to a receiver, a transmitter, a transceiver, one or more other components described in the present disclosure, or a combination thereof in accordance with various aspects of the present disclosure.

Link aggregation manager 815 may schedule the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band. Link aggregation manager 815 may also aggregate the data flows for transmission over the first sub-band of the shared radio frequency spectrum band and the second sub-band of the shared radio frequency spectrum band based at least in part on the scheduling.

Transmitter 820 may transmit signals generated by other components of the device. In some examples, the transmitter 820 may be collocated with a receiver 810 in a transceiver module. For example, the transmitter 820 may be an example of aspects of transceiver described with reference to FIGS. 11 and 12. The transmitter 820 may include a single antenna, or it may include a set of antennas.

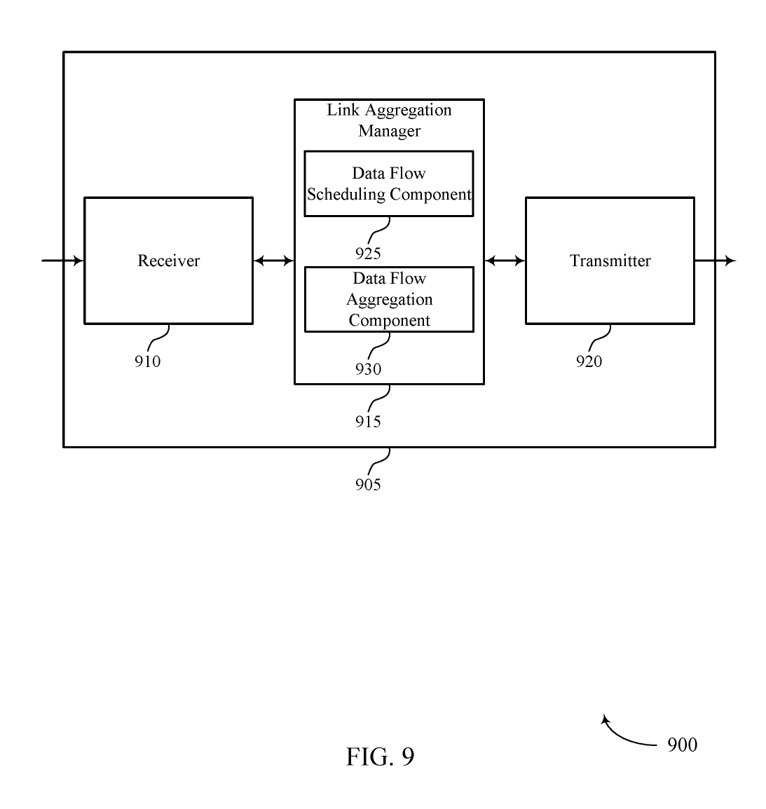

FIG. 9 shows a block diagram 900 of a wireless device 905 that supports Wi-Fi link aggregation to improve throughput performance in accordance with various aspects of the present disclosure. Wireless device 905 may be an example of aspects of a wireless device 805 or a STA 115 or AP 105 as described with reference to FIGS. 1 and 8. Wireless device 905 may include receiver 910, link aggregation manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to Wi-Fi link aggregation to improve throughput performance, etc.). Information may be passed on to other components of the device. The receiver 910 may be an example of aspects of transceiver described with reference to FIGS. 11 and 12. Link aggregation manager 915 may be an example of aspects of the link aggregation manager 815 described with reference to FIG. 8. Link aggregation manager 915 may also include data flow scheduling component 925 and data flow aggregation component 930.

Receiver 910 may receive, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer. Receiver 910 may receive, at the first protocol layer, a request for an amount of bandwidth from the second protocol layer. In some cases, receiver 910 may receive a vendor specific IE in a data packet of at least one of the data flows.

Data flow scheduling component 925 may schedule the data flows from the first protocol layer or the second protocol layer to the first sub-band of the shared radio frequency spectrum band or the second sub-band of the shared radio frequency spectrum band based on a parameter associated with the data flows and at least one metric associated with at least one of the first sub-band of the shared radio frequency spectrum band or the second sub-band of the shared radio frequency spectrum band, schedule subsequent data flows to the second sub-band of the shared radio frequency spectrum band based on the determining, configure, for the data flows, a receiver address, or a transmitter address, or a destination address, or a source address, or a combination thereof. In some cases, data flow scheduling component 925 may schedule data packets of a data flow for transmission on the first sub-band of the shared radio frequency spectrum band or the second sub-band of the shared radio frequency spectrum band based on a VLAN tag. Data flow scheduling component 925 may identify a VLAN tag associated with the data flows, forward the received data flows from the first protocol layer to the first sub-band of the shared radio frequency spectrum band or the second sub-band of the shared radio frequency spectrum band based on the identified VLAN tag, and remove the VLAN tag from the received data flows prior to forwarding the received data flows.

Data flow scheduling component 925 may schedule the data flows to the second sub-band of the shared radio frequency spectrum band based on the determination, forward the received data flows from the first protocol layer to the first sub-band of the shared radio frequency spectrum band or the second sub-band of the shared radio frequency spectrum band based on the decoded address. In some cases, data flow scheduling component 925 may schedule the data flows to the second sub-band of the shared radio frequency spectrum band based on determining that a transmission bandwidth of the first sub-band of the shared radio frequency spectrum band satisfies a transmission bandwidth threshold. Data flow scheduling component 925 may schedule subsequent data flows to the second sub-band of the shared radio frequency spectrum band based on the determining. Data flow scheduling component 925 may configure an address field for the data flows to include an indication of tunneling over the second sub-band, receive a vendor specific IE in a data packet of at least one of the data flows, utilize the at least one vendor specific IE to exchange bonding capabilities, and decode an address associated with the data flows. The address may be a source address, or a destination address, or a combination thereof. In some cases, the vendor specific IE includes a buffer size, or a MAC address, or a channel number, or a bandwidth, or a number of chains, or a combination thereof, of at least one of the first sub-band of the shared radio frequency spectrum band or the second sub-band of the shared radio frequency spectrum band. In some cases, the decoding is performed at a host driver layer.

Additionally or alternatively, data flow scheduling component 925 may establish a communication link. In some cases, the scheduling the data flows to the second sub-band of the shared radio frequency spectrum band includes transmitting the data flows via the second sub-band of the shared radio frequency spectrum band using the established communication link. In some cases, scheduling the data packets includes removing the VLAN tag from the data packets prior to transmitting the data packets.

Data flow aggregation component 930 may aggregate the data flows for transmission over the first sub-band of the shared radio frequency spectrum band and the second sub-band of the shared radio frequency spectrum band based on the scheduling, identify an aggregation mode based on information associated with the received data flows, and aggregate the data flows over the first sub-band of the shared radio frequency spectrum band and the second sub-band of the shared radio frequency spectrum band is further based on the identified aggregation mode.

In some cases, data flow aggregation component 930 may identify an aggregation mode based on information associated with the data flows. For examples, data flow aggregation component 930 may identify a VLAN tag associated with data packets of the data flow and identify an aggregation mode based on the VLAN tag. In some examples, data flow aggregation component 930 may configure an address field associated with data packets of the data flows, decode a destination address associated with the data packets of the data flows, and receive at least one vendor specific information element (IE) in a data packet of a data flow. In some cases, the address field includes at least one of a receiver address, a transmitter address, a destination address, a source address, or a combination thereof.

In some cases, identifying the aggregation mode includes receiving the data flows at the first protocol layer of the wireless device. In some cases, identifying the aggregation mode includes decoding a source address associated with data packets of the data flows. In some cases, the at least one vendor specific IE includes at least one a buffer size, a media access control (MAC) address of at least one of the primary radio communication link or the secondary radio communication link, a channel number of the at least one of the primary radio communication link or the secondary radio communication link, a bandwidth of the at least one of the primary radio communication link or the secondary radio communication link, and a number of chains of the at least one of the primary radio communication link or the secondary radio communication link.

Transmitter 920 may transmit signals generated by other components of the device. In some examples, the transmitter 920 may be collocated with a receiver 910 in a transceiver module. For example, the transmitter 920 may be an example of aspects of transceiver described with reference to FIGS. 11 and 12. The transmitter 920 may include a single antenna, or it may include a set of antennas.

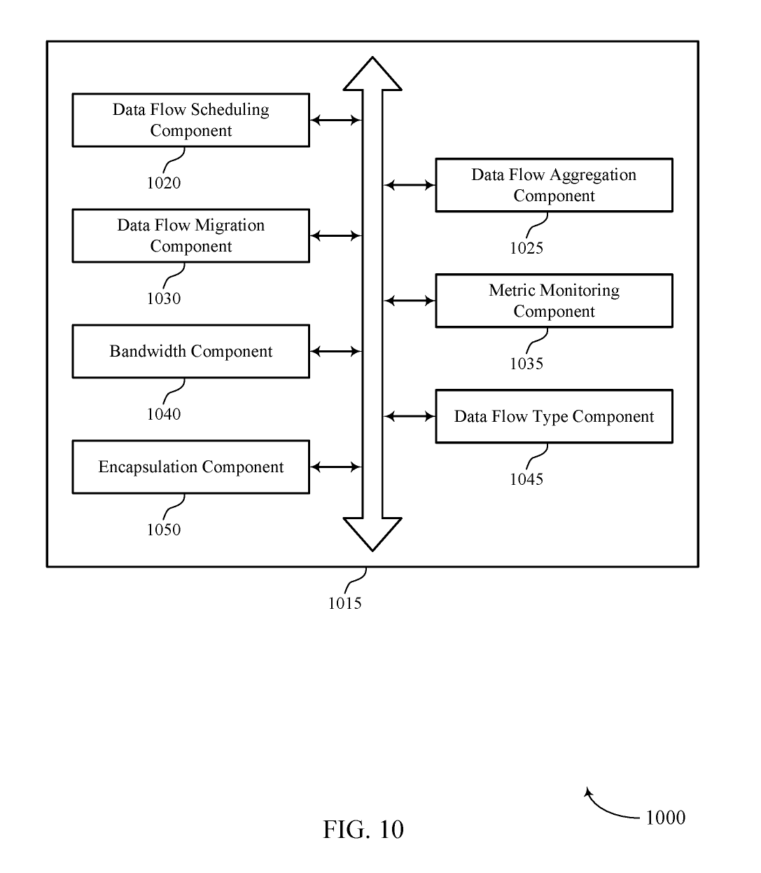

FIG. 10 shows a block diagram 1000 of a link aggregation manager 1015 that supports Wi-Fi link aggregation to improve throughput performance in accordance with various aspects of the present disclosure. The link aggregation manager 1015 may be an example of aspects of a link aggregation manager 815 or a link aggregation manager 915 described with reference to FIGS. 8 and 9. The link aggregation manager 1015 may include data flow scheduling component 1020, data flow aggregation component 1025, data flow migration component 1030, metric monitoring component 1035, bandwidth component 1040, data flow type component 1045, and encapsulation component 1050. Each of these modules may communicate, directly or indirectly, with one another (e.g., via one or more buses).

Data flow scheduling component 1020 may schedule the data flows from the first protocol layer or the second protocol layer to the first sub-band of the shared radio frequency spectrum band or the second sub-band of the shared radio frequency spectrum band based on a parameter associated with the data flows and at least one metric associated with at least one of the first sub-band of the shared radio frequency spectrum band or the second sub-band of the shared radio frequency spectrum band, schedule subsequent data flows to the second sub-band of the shared radio frequency spectrum band based on the determining, configure, for the data flows, a receiver address, or a transmitter address, or a destination address, or a source address, or a combination thereof, identify a virtual local area network (VLAN) tag associated with the data flows, forward the received data flows from the first protocol layer to the first sub-band of the shared radio frequency spectrum band or the second sub-band of the shared radio frequency spectrum band based on the identified VLAN tag, remove the VLAN tag from the received data flows prior to forwarding the received data flows.

Data flow scheduling component 1020 may in some cases, schedule the data flows to the second sub-band of the shared radio frequency spectrum band based on the determination, forward the received data flows from the first protocol layer to the first sub-band of the shared radio frequency spectrum band or the second sub-band of the shared radio frequency spectrum band based on the decoded address, configure an address field for the data flows to include an indication of tunneling over the second sub-band, receive a vendor specific IE in a data packet of at least one of the data flows, utilize the at least one vendor specific IE to exchange bonding capabilities, and decode an address associated with the data flows, where the address is a source address, or a destination address, or a combination thereof. In some cases, the vendor specific IE includes a buffer size, or a MAC address, or a channel number, or a bandwidth, or a number of chains, or a combination thereof, of at least one of the first sub-band of the shared radio frequency spectrum band or the second sub-band of the shared radio frequency spectrum band. In some cases, the decoding is performed at a host driver layer.

Data flow aggregation component 1025 may aggregate the data flows for transmission over the first sub-band of the shared radio frequency spectrum band and the second sub-band of the shared radio frequency spectrum band based on the scheduling, identify an aggregation mode based on information associated with the received data flows, and aggregate the data flows over the first sub-band of the shared radio frequency spectrum band and the second sub-band of the shared radio frequency spectrum band is further based on the identified aggregation mode. Data flow migration component 1030 may migrate data flows scheduled to the first sub-band of the shared radio frequency spectrum band to the second sub-band of the shared radio frequency spectrum band based on the parameter.

Metric monitoring component 1035 may determine that the at least one metric of the first sub-band of the shared radio frequency spectrum band satisfies a transmission bandwidth threshold, the at least one metric including a transmission bandwidth. Metric monitoring component 1035 may monitor the at least one metric associated with the at least one of the first sub-band of the shared radio frequency spectrum band or the second sub-band of the shared radio frequency spectrum band, determine that a value for the at least one monitored metric for the first sub-band of the shared radio frequency spectrum band exceeds a predetermined threshold, and analyze the at least one metric associated with the at least one of the first sub-band of the shared radio frequency spectrum band or the second sub-band of the shared radio frequency spectrum band based on the received request.

Bandwidth component 1040 may allocate a portion of bandwidth for the first sub-band of the shared radio frequency spectrum band to the second sub-band of the shared radio frequency spectrum band based on the analyzing. Data flow type component 1045 may analyze a hash mapper table based on the received data flows and forward the received data flows from the first protocol layer to the first sub-band of the shared radio frequency spectrum band or the second sub-band of the shared radio frequency spectrum band based on the analyzed hash mapper table.

Encapsulation component 1050 may encapsulate a data packet of at least one of the data flows to include at least two MAC address types, encapsulate a data packet of at least one of the data flows to include an outer MAC header and an inner MAC header, and preserve the inner MAC header based on the outer MAC header. In some cases, the at least two MAC address types include a source address and a destination address. In some cases, the encapsulated data packet further includes at least two Ethernet address types and a VLAN indication.

FIG. 11 shows a diagram of a system 1100 including a device 1105 that supports Wi-Fi link aggregation to improve throughput performance in accordance with various aspects of the present disclosure. Device 1105 may be an example of or include the components of wireless device 805, wireless device 905, or STA 115 as described above, e.g., with reference to FIGS. 1, 8 and 9. Device 1105 may include components for bi-directional voice and data communications including components for transmitting and receiving communications, including STA link aggregation manager 1115, processor 1120, memory 1125, software 1130, transceiver 1135, antenna 1140, and I/O controller 1145. These components may be in electronic communication via one or more busses (e.g., bus 1110). Device 1105 may communicate wirelessly with one or more APs 105.

Processor 1120 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting Wi-Fi link aggregation to improve throughput performance).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices. Software 1130 may include code to implement aspects of the present disclosure, including code to support Wi-Fi link aggregation to improve throughput performance. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas. In some cases, the wireless device may include a single antenna 1140. However, in some cases the device may have more than one antenna 1140, which may be capable of concurrently transmitting or receiving multiple wireless transmissions. For example, antenna 1240 may be associated with a first sub-band of the shared frequency spectrum band and the second sub-band of the shared frequency spectrum. In some cases, the first sub-band may include a 2.4 GHz band link and the second sub-band may include a 5 GHz band link.

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system.

FIG. 12 shows a diagram of a system 1200 including a device 1205 that supports Wi-Fi link aggregation to improve throughput performance in accordance with various aspects of the present disclosure. Device 1205 may be an example of or include the components of wireless device 805, wireless device 905, or AP 105 as described above, e.g., with reference to FIGS. 1, 8 and 9. Device 1205 may include components for bi-directional voice and data communications including components for transmitting and receiving communications, including access point link aggregation manager 1215, processor 1220, memory 1225, software 1230, transceiver 1235, antenna 1240, network communications manager 1245, and access point communications manager 1250. These components may be in electronic communication via one or more busses (e.g., bus 1210). Device 1205 may communicate wirelessly with one or more STAs 115.

Processor 1220 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting Wi-Fi link aggregation to improve throughput performance).

Memory 1225 may include RAM and ROM. The memory 1225 may store computer-readable, computer-executable software 1230 including instructions that, when executed, cause the processor to perform various functions described herein. In some cases, the memory 1225 may contain, among other things, a BIOS which may control basic hardware and/or software operation such as the interaction with peripheral components or devices. Software 1230 may include code to implement aspects of the present disclosure, including code to support Wi-Fi link aggregation to improve throughput performance. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions. For example, antenna 1240 may be associated with a first sub-band of the shared frequency spectrum band and the second sub-band of the shared frequency spectrum. In some cases, the first sub-band may include a 2.4 GHz band link and the second sub-band may include a 5 GHz band link.

Network communications manager 1245 may manage communications with the core network (e.g., via one or more wired backhaul links). For example, the network communications manager 1245 may manage the transfer of data communications for client devices, such as one or more STAs 115. Access point communications manager 1250 may manage communications with other APs 105, and may include a controller or scheduler for controlling communications with STAs 115 in cooperation with other APs 105. For example, the access point communications manager 1250 may coordinate scheduling for transmissions to STAs 115 for various interference mitigation techniques such as beamforming or joint transmission. In some examples, access point communications manager 1250 may provide an X2 interface within an LTE/LTE-A wireless communication network technology to provide communication between APs 105.

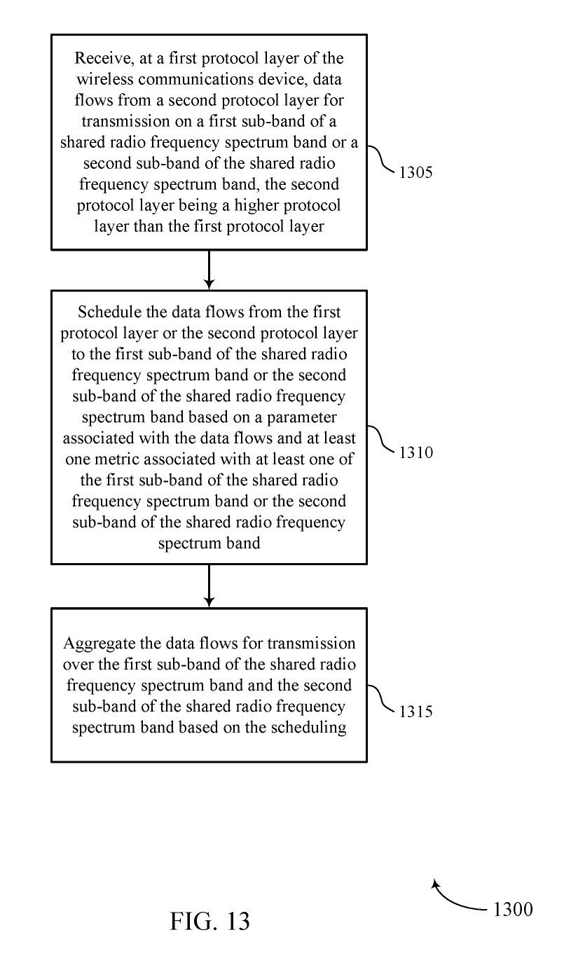

FIG. 13 shows a flowchart illustrating a method 1300 for Wi-Fi link aggregation to improve throughput performance in accordance with various aspects of the present disclosure. The operations of method 1300 may be implemented by a STA 115 or AP 105 or its components as described herein. For example, the operations of method 1300 may be performed by a link aggregation manager as described with reference to FIGS. 8 through 10. In some examples, STA 115 or AP 105 may execute a set of codes to control the functional elements of the device to perform the functions described below. Additionally or alternatively, STA 115 or AP 105 may perform aspects the functions described below using special-purpose hardware.

At block 1305, STA 115 or AP 105 may receive, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer. The operations of block 1305 may be performed according to the methods described with reference to FIGS. 1 through 7. In certain examples, aspects of the operations of block 1305 may be performed by a receiver as described with reference to FIGS. 8 and 9.

At block 1310, STA 115 or AP 105 may schedule the data flows from the first protocol layer or the second protocol layer to the first sub-band of the shared radio frequency spectrum band or the second sub-band of the shared radio frequency spectrum band based on a parameter associated with the data flows and at least one metric associated with at least one of the first sub-band of the shared radio frequency spectrum band or the second sub-band of the shared radio frequency spectrum band. The operations of block 1310 may be performed according to the methods described with reference to FIGS. 1 through 7. In certain examples, aspects of the operations of block 1310 may be performed by a data flow scheduling component as described with reference to FIGS. 9 and 10.

At block 1315, STA 115 or AP 105 may aggregate the data flows for transmission over the first sub-band of the shared radio frequency spectrum band and the second sub-band of the shared radio frequency spectrum band based at least in part on the scheduling. The operations of block 1315 may be performed according to the methods described with reference to FIGS. 1 through 7. In certain examples, aspects of the operations of block 1315 may be performed by a data flow aggregation component as described with reference to FIGS. 9 and 10.

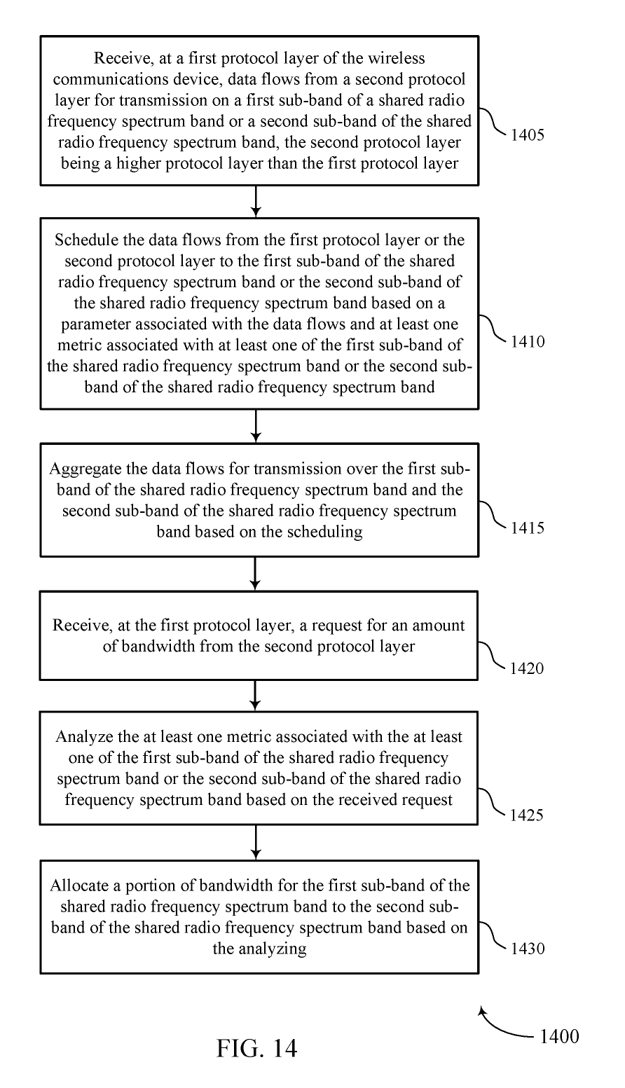

FIG. 14 shows a flowchart illustrating a method 1400 for Wi-Fi link aggregation to improve throughput performance in accordance with various aspects of the present disclosure. The operations of method 1400 may be implemented by a STA 115 or AP 105 or its components as described herein. For example, the operations of method 1400 may be performed by a link aggregation manager as described with reference to FIGS. 8 through 10. In some examples, a STA 115 or AP 105 may execute a set of codes to control the functional elements of the device to perform the functions described below. Additionally or alternatively, the STA 115 or AP 105 may perform aspects the functions described below using special-purpose hardware.

At block 1405, STA 115 or AP 105 may receive, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer. The operations of block 1405 may be performed according to the methods described with reference to FIGS. 1 through 7. In certain examples, aspects of the operations of block 1405 may be performed by a receiver as described with reference to FIGS. 8 and 9.

At block 1410, STA 115 or AP 105 may schedule the data flows from the first protocol layer or the second protocol layer to the first sub-band of the shared radio frequency spectrum band or the second sub-band of the shared radio frequency spectrum band based on a parameter associated with the data flows and at least one metric associated with at least one of the first sub-band of the shared radio frequency spectrum band or the second sub-band of the shared radio frequency spectrum band. The operations of block 1410 may be performed according to the methods described with reference to FIGS. 1 through 7. In certain examples, aspects of the operations of block 1410 may be performed by a data flow scheduling component as described with reference to FIGS. 9 and 10.

At block 1415, STA 115 or AP 105 may aggregate the data flows for transmission over the first sub-band of the shared radio frequency spectrum band and the second sub-band of the shared radio frequency spectrum band based at least in part on the scheduling. The operations of block 1415 may be performed according to the methods described with reference to FIGS. 1 through 7. In certain examples, aspects of the operations of block 1415 may be performed by a data flow aggregation component as described with reference to FIGS. 9 and 10.

At block 1420, STA 115 or AP 105 may receive, at the first protocol layer, a request for an amount of bandwidth from the second protocol layer. The operations of block 1420 may be performed according to the methods described with reference to FIGS. 1 through 7. In certain examples, aspects of the operations of block 1420 may be performed by a receiver as described with reference to FIGS. 8 and 9.

At block 1425, STA 115 or AP 105 may analyze the at least one metric associated with the at least one of the first sub-band of the shared radio frequency spectrum band or the second sub-band of the shared radio frequency spectrum band based on the received request. The operations of block 1425 may be performed according to the methods described with reference to FIGS. 1 through 7. In certain examples, aspects of the operations of block 1425 may be performed by a data flow type component as described with reference to FIGS. 9 and 10.

At block 1430, STA 115 or AP 105 may allocate a portion of bandwidth for the first sub-band of the shared radio frequency spectrum band to the second sub-band of the shared radio frequency spectrum band based on the analyzing. The operations of block 1430 may be performed according to the methods described with reference to FIGS. 1 through 7. In certain examples, aspects of the operations of block 1430 may be performed by a data flow migration component as described with reference to FIGS. 9 and 10.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communication system 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, comprising:
a processor;
memory in electronic communication with the processor; and
instructions stored in the memory and operable, when executed by the processor, to cause the apparatus to:
receive, at a first protocol layer of the apparatus, data flows from a second protocol layer for transmission on a first sub-band of a shared radio frequency spectrum band or a second sub-band of the shared radio frequency spectrum band, the second protocol layer being a higher protocol layer than the first protocol layer;
schedule the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and
aggregate the data flows for transmission over the first sub-band of the shared radio frequency spectrum band and the second sub-band of the shared radio frequency spectrum band based at least in part on the scheduling.

2. The apparatus of claim 1, wherein the instructions to schedule the data flows are further executable by the processor to cause the apparatus to:
migrate data flows scheduled to the first sub-band of the shared radio frequency spectrum band to the second sub-band of the shared radio frequency spectrum band based at least in part on the parameter; and
transmit the migrated data flows over the second sub-band of the shared radio frequency spectrum band.

3. The apparatus of claim 1, wherein the instructions to schedule the data flows are further executable by the processor to cause the apparatus to:
determine that the at least one metric of the first sub-band of the shared radio frequency spectrum band satisfies a transmission bandwidth threshold, the at least one metric comprising a transmission bandwidth; and
schedule the data flows to the second sub-band of the shared radio frequency spectrum band based at least in part on the determination.

4. The apparatus of claim 1, wherein the instructions are further executable by the processor to cause the apparatus to:
monitor the at least one metric associated with the at least one of the first sub-band of the shared radio frequency spectrum band or the second sub-band of the shared radio frequency spectrum band;
determine that a value for the at least one monitored metric for the first sub-band of the shared radio frequency spectrum band exceeds a predetermined threshold; and
schedule subsequent data flows to the second sub-band of the shared radio frequency spectrum band based at least in part on the determination.

5. The apparatus of claim 1, wherein the instructions are further executable by the processor to cause the apparatus to:
receive, at the first protocol layer, a request for an amount of bandwidth from the second protocol layer;
analyze the at least one metric associated with the at least one of the first sub-band of the shared radio frequency spectrum band or the second sub-band of the shared radio frequency spectrum band based at least in part on the received request; and
allocate a portion of bandwidth for the first sub-band of the shared radio frequency spectrum band to the second sub-band of the shared radio frequency spectrum band based at least in part on the analysis.

6. The apparatus of claim 1, wherein the instructions are further executable by the processor to cause the apparatus to:
configure, for the data flows, a receiver address, or a transmitter address, or a destination address, or a source address, or a combination thereof.

7. The apparatus of claim 1, wherein the instructions to aggregate the data flows are further executable by the processor to cause the apparatus to:
identify an aggregation mode based at least in part on information associated with the received data flows; and
aggregate the data flows over the first sub-band of the shared radio frequency spectrum band and the second sub-band of the shared radio frequency spectrum band is further based at least in part on the identified aggregation mode.

8. The apparatus of claim 1, wherein the instructions are further executable by the processor to cause the apparatus to:
identify a virtual local area network (VLAN) tag associated with the data flows; and
forward the received data flows from the first protocol layer to the first sub-band of the shared radio frequency spectrum band or the second sub-band of the shared radio frequency spectrum band based at least in part on the identified VLAN tag.

9. The apparatus of claim 8, wherein the instructions are further executable by the processor to cause the apparatus to:
remove the VLAN tag from the received data flows prior to forwarding the received data flows.

10. The apparatus of claim 1, wherein the instructions are further executable by the processor to cause the apparatus to:
analyze a hash mapper table based at least in part on the received data flows; and
forward the received data flows from the first protocol layer to the first sub-band of the shared radio frequency spectrum band or the second sub-band of the shared radio frequency spectrum band based at least in part on the analyzed hash mapper table.

11. The apparatus of claim 1, wherein the instructions are further executable by the processor to cause the apparatus to:
decode an address associated with the data flows, wherein the address is a source address, or a destination address, or a combination thereof; and
forward the received data flows from the first protocol layer to the first sub-band of the shared radio frequency spectrum band or the second sub-band of the shared radio frequency spectrum band based at least in part on the decoded address.

12. The apparatus of claim 11, wherein the decoding is performed at a host driver layer.

13. The apparatus of claim 1, wherein the instructions are further executable by the processor to cause the apparatus to:
configure an address field for the data flows to include an indication of tunneling over the second sub-band.

14. The apparatus of claim 1, wherein the instructions are further executable by the processor to cause the apparatus to:
receive a vendor specific information element (IE) in a data packet of at least one of the data flows; and
utilize the at least one vendor specific IE to exchange bonding capabilities.

15. The apparatus of claim 14, wherein the vendor specific IE comprises a buffer size, or a media access control (MAC) address, or a channel number, or a bandwidth, or a number of chains, or a combination thereof, of at least one of the first sub-band of the shared radio frequency spectrum band or the second sub-band of the shared radio frequency spectrum band.

16. The apparatus of claim 1, wherein the instructions are further executable by the processor to cause the apparatus to:
encapsulate a data packet of at least one of the data flows to include at least two media access control (MAC) address types.

17. The apparatus of claim 16, wherein the at least two MAC address types comprise a source address and a destination address.

18. The apparatus of claim 17, wherein the encapsulated data packet further comprises at least two Ethernet address types and a virtual local area network (VLAN) indication.

19. The apparatus of claim 1, wherein the instructions are further executable by the processor to cause the apparatus to:
encapsulate a data packet of at least one of the data flows to include an outer media access control (MAC) header and an inner MAC header; and
preserve the inner MAC header based at least in part on the outer MAC header.

20. The apparatus of claim 1, wherein the at least one metric comprises a signal strength, or a transmission bandwidth, or a link capacity, or a combination thereof.

21. The apparatus of claim 1, wherein the parameter comprises at least one a power saved mode, or link statistics, or a link failure indication, or data flow statistics, or rate adaptation, or input from a framework, or a combination thereof.

22. The apparatus of claim 1, wherein:
the data flows are scheduled at the second protocol layer, the second protocol layer comprising an application layer; and
the data flows are aggregated at the first protocol layer, the first protocol layer comprising a host driver layer.

23. The apparatus of claim 1, wherein the apparatus is a wireless communication terminal and further comprises an antenna and a transceiver.

24. The apparatus of claim 1, wherein:
the first sub-band of the shared radio frequency spectrum band comprises a 2.4 GHz band link; and
the second sub-band of the shared radio frequency spectrum band comprises a 5 GHz band link.

25. A method for wireless communication from a wireless communications device, comprising:
receiving, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer;
scheduling the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and
aggregating the data flows for transmission over the first sub-band of the shared radio frequency spectrum band and the second sub-band of the shared radio frequency spectrum band based at least in part on the scheduling.

26. The method of claim 25, wherein scheduling the data flows further comprises:
migrating data flows scheduled to the first sub-band of the shared radio frequency spectrum band to the second sub-band of the shared radio frequency spectrum band based at least in part on the parameter; and
transmitting the migrated data flows over the second sub-band of the shared radio frequency spectrum band.

27. An apparatus for wireless communication from a wireless communications device, comprising:
means for receiving, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer;
means for scheduling the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and
means for aggregating the data flows for transmission over the first sub-band of the shared radio frequency spectrum band and the second sub-band of the shared radio frequency spectrum band based at least in part on the scheduling.

28. The apparatus of claim 27, wherein the means for scheduling the data flows further comprise:
means for migrating data flows scheduled to the first sub-band of the shared radio frequency spectrum band to the second sub-band of the shared radio frequency spectrum band based at least in part on the parameter; and
means for transmitting the migrated data flows over the second sub-band of the shared radio frequency spectrum band.

29. A non-transitory computer readable medium storing code for wireless communication from a wireless communications device, the code comprising instructions executable by a processor to:
receive, at a first protocol layer of the wireless communications device, data flows from a second protocol layer for transmission on a first sub-band of a shared radio frequency spectrum band or a second sub-band of the shared radio frequency spectrum band, the second protocol layer being a higher protocol layer than the first protocol layer;
schedule the data flows from the first protocol layer or the second protocol layer to the first sub-band of the shared radio frequency spectrum band or the second sub-band of the shared radio frequency spectrum band based at least in part on a parameter associated with the data flows and at least one metric associated with at least one of the first sub-band of the shared radio frequency spectrum band or the second sub-band of the shared radio frequency spectrum band; and
aggregate the data flows for transmission over the first sub-band of the shared radio frequency spectrum band and the second sub-band of the shared radio frequency spectrum band based at least in part on the scheduling.

30. The non-transitory computer readable medium of claim 29, wherein the code comprising instructions executable by a processor to schedule the data flows further comprises code comprising instructions executable by the processor to:
migrate data flows scheduled to the first sub-band of the shared radio frequency spectrum band to the second sub-band of the shared radio frequency spectrum band based at least in part on the parameter; and
transmit the migrated data flows over the second sub-band of the shared radio frequency spectrum band.
